(19) United States
(12) Patent Application Publication
(10) Pub. No.: US 2025/0343986 A1
(43) Pub. Date: Nov. 6, 2025

(54) DETECTION SYSTEM

(71) Applicant: Japan Display Inc., Tokyo (JP)

(72) Inventor: Masayuki IKARI, Tokyo (JP)

(21) Appl. No.: 19/178,382

(22) Filed: Apr. 14, 2025

(30) Foreign Application Priority Data
Apr. 15, 2024 (JP) 2024-065536

(51) Int. Cl. H04N 23/61; F21V 8/00; G01G 23/38; G06Q 10/087; G06Q 30/0601; G06V 20/52

(52) U.S. Cl. CPC H04N 23/61; G01G 23/38; G02B 6/009; G06Q 10/08772; G06Q 30/0639; G06V 20/52

(57) ABSTRACT

According to an aspect, a detection system includes: a server configured to hold pattern data to identify a type of a product handled in a store; and a detection device provided so as to be capable of communicating with the server and configured to identify the product. The detection device includes: a sensor provided along a placement surface of a shelf provided so as to allow a plurality of the products to be placed thereon; and an information processor configured to identify types of the products and the number of each of the types of the products by comparing an output of the sensor to the pattern data. The sensor comprises a planar optical sensor located so as to face the products with the placement surface interposed between the planar optical sensor and the products.

### CROSS-REFERENCE TO RELATED APPLICATION

This application claims the benefit of priority from Japanese Patent Application No. 2024-065536 filed on Apr. 15, 2024, the entire contents of which are incorporated herein by reference.

### BACKGROUND

### 1. Technical Field

What is disclosed herein relates to a detection system.

### 2. Description of the Related Art

As described in Japanese Patent Application Laid-open Publication No. 2021-189691 (JP-A-2021-189691), there have been known methods for managing movement of products from/to shelves by combining an imaging device and a weight sensor.

A method described in JP-A-2021-189691 requires a plurality of operational constraints to detect the movement of products, and equipment to achieve the method is difficult to be installed and operated. More specifically, for example, the placement and the angle of view of the imaging device need to be set so that image capturing is not blocked by customers taking out the products, and all the products need to be within an imaging region of the imaging device. Considering the increase in accuracy of identification of the products using the weight sensor, conditions are further added, such as not to place a plurality of types of products having the same weight on the same weight sensor, to eliminate individual differences in weight of the products regarded as the same type of product, and to provide an individual weight sensor for each space for placing the products that cannot be distinguished by weight. These conditions further make the operation difficult.

For the foregoing reasons, there is a need for a detection system capable of more reliably sensing products and more easily be installed.

### SUMMARY

According to an aspect, a detection system includes: a server configured to hold pattern data to identify a type of a product handled in a store; and a detection device provided so as to be capable of communicating with the server and configured to identify the product. The detection device includes: a sensor provided along a placement surface of a shelf provided so as to allow a plurality of the products to be placed thereon; and an information processor configured to identify types of the products and the number of each of the types of the products by comparing an output of the sensor to the pattern data. The sensor comprises a planar optical sensor located so as to face the products with the placement surface interposed between the planar optical sensor and the products. The planar optical sensor has a resolution capable of identifying a shape of one surface, which faces the placement surface, of each of the products placed on the placement surface, and characters, identifiers, and patterns marked on the one surface. The pattern data comprises information indicating the shape of the one surface, and the characters, the identifiers, and the patterns marked on the one surface.

### BRIEF DESCRIPTION OF THE DRAWINGS

FIG. 1 is a block diagram illustrating a main configuration of a detection system;

FIG. 2 is schematic overhead view of a store provided with a first gate and a second gate of the detection system;

FIG. 3 is a schematic diagram illustrating a configuration example of a shelf;

FIG. 4 is a schematic multilayer diagram illustrating a main configuration of a shelf board with a sensing function;

FIG. 5 is a block diagram illustrating a configuration related to an operation of a planar optical sensor and a functional configuration related to information processing performed based on light detected by the planar optical sensor;

FIG. 6 is a schematic diagram illustrating exemplary states of the shelf board with a sensing function and products on the shelf board with a sensing function before and after the number of the placed products changes;

FIG. 7 illustrates a schematic diagram illustrating methods for identifying products;

FIG. 8 is a schematic diagram illustrating exemplary cases where arrangements of some or all of the products in a sensing area do not match between before and after a change;

FIG. 9 is a schematic diagram illustrating a configuration of a second database (DB);

FIG. 10 is a table illustrating exemplary content of product data;

FIG. 11 is a table illustrating exemplary content of customer data;

FIG. 12 is a diagram illustrating a configuration of a first DB;

FIG. 13 is a table illustrating exemplary content of product inventory data;

FIG. 14 is a table illustrating exemplary content of store-specific customer data;

FIG. 15 is a table illustrating exemplary content of buyer data;

FIG. 16 is a schematic diagram illustrating exemplary cases where a position of a product placed on the shelf is moved by a customer;

FIG. 17 is a table illustrating exemplary content of the product inventory data after an occurrence of a “first pattern”;

FIG. 18 is a table illustrating exemplary content of the store-specific customer data after the occurrence of the “first pattern”;

FIG. 19 is a table illustrating exemplary content of the buyer data after the occurrence of the “first pattern”;

FIG. 20 is a table illustrating exemplary content of the product inventory data after an occurrence of a “second pattern”;

FIG. 21 is a table illustrating exemplary content of the buyer data when customer-specific information in the buyer data is a customer-specific number;

FIG. 22 is a flowchart of processing when a payment process is automatically performed at the time of exit from the store;

FIG. 23 is a flowchart of a store entry process;

FIG. 24 is a flowchart of a product movement determination process;

FIG. 25 is a flowchart of a first store exit process;

FIG. 26 is a flowchart of processing when the customer voluntarily manages the products taken off the shelf using a terminal device;

FIG. 27 is a flowchart of a second store exit process;

FIG. 28 is a flowchart of processing when the customer is assumed to use a self-checkout system to complete a payment before entering the second gate;

FIG. 29 is a flowchart of a third store exit process;

FIG. 30 is a schematic diagram illustrating exemplary preliminary measures for providing surfaces that can be stably placed on a sensing area AA to the products having shapes that have no surfaces that can be stably placed on the sensing area;

FIG. 31 is a schematic diagram illustrating a vending machine accommodating the products; and

FIG. 32 is a schematic diagram illustrating a locker accommodating the products.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

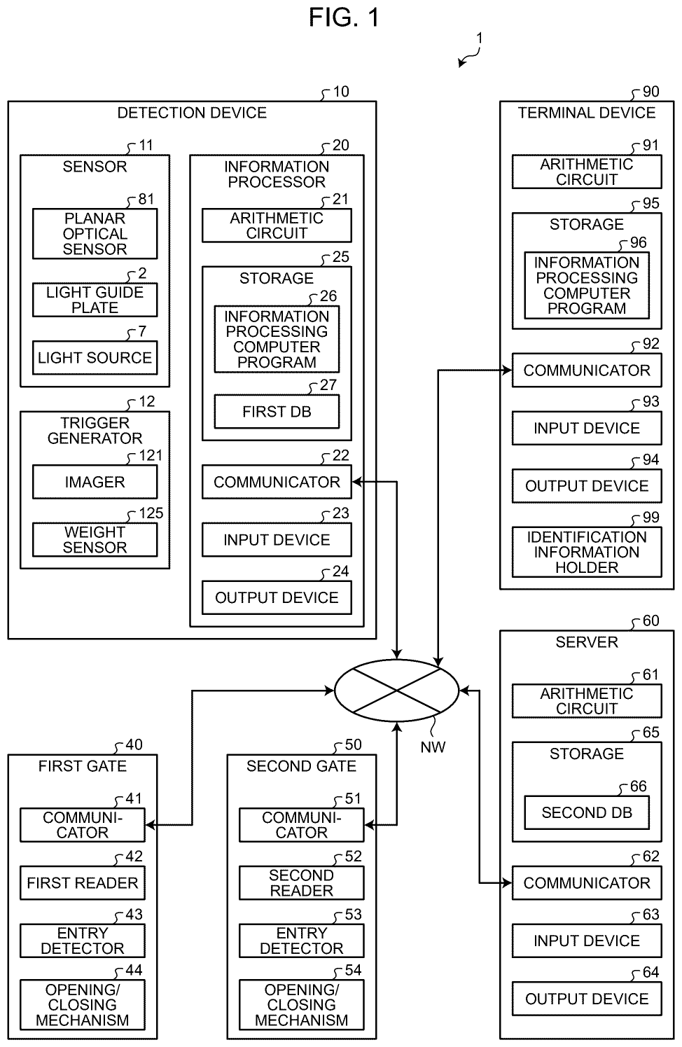

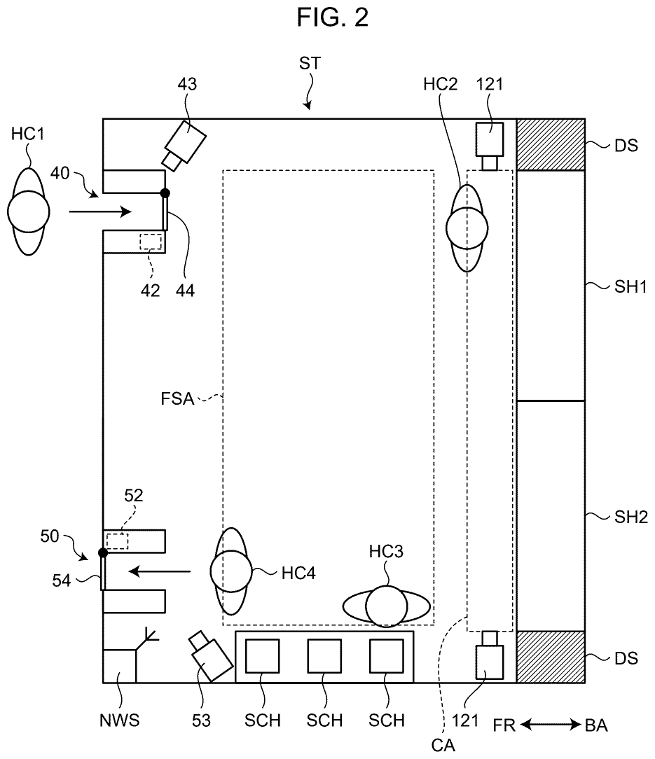

FIG. 1 is a block diagram illustrating a main configuration of a detection system 1. The detection system 1 includes a detection device 10, a first gate 40, a second gate 50, a server 60, and a terminal device 90. FIG. 2 is schematic overhead view of a store ST provided with the first gate 40 and the second gate 50 of the detection system 1. The first gate 40 is provided at an entrance for a customer HC to enter the store ST. FIG. 2 illustrates customers HC1, HC2, HC3, and HC4 as specific examples of the customer HC. Hereinafter, the term “customer HC” refers to a person who can be a customer of the store ST, such as the customers HC1, HC2, HC3, and HC4. As illustrated in FIGS. 1 and 2, the first gate 40 includes a first reader 42, an entry detector 43, and an opening/closing mechanism 44.

The first reader 42 reads identification information held in the terminal device 90 of the customer HC. The identification information is held by an identification information holder 99 of the terminal device 90. The identification information holder 99 corresponds to the first reader 42 in specific implementation. For example, when the identification information holder 99 is assumed to be a radio frequency (RF) tag used in radio frequency identification (RFID), the first reader 42 is a reading device of the RF tag. This explanation is merely an example of a combination of the first reader 42 with the identification information holder 99, and the embodiment is not limited to this explanation. For example, the first reader 42 may have a configuration that allows acquisition of the identification information through contactless communication conforming to a plurality of standards. The entry detector 43 detects entry of the customer HC into the first gate 40. In FIG. 2, the entry detector 43 employs a mechanism to capture an image of the first gate 40 and the vicinity thereof and detect the image of the customers HC included in the captured image, but the specific configuration of the entry detector 43 is not limited to this configuration. For example, the entry detector 43 may be configured to determine that the customer HC has entered the first gate 40 when detecting an interruption of infrared light or other light in the entry path for the customer HC at the first gate 40. The entry detector 43 activates operations of the first reader 42 and the opening/closing mechanism 44 in response to the detection of the customer HC. In other words, if the entry detector 43 does not detects the entry of the customer HC for a predetermined active time or longer, the first reader 42 and the opening/closing mechanism 44 enter a sleep state. This operation reduces the power consumption of the first gate 40.

The opening/closing mechanism 44 is provided in the entry path for the customer HC at the first gate 40. The opening/closing mechanism 44 operates so as to restrict the entry of the customers HC who are not allowed to enter the store ST. FIG. 2 schematically illustrates what is called a flap-door opening/closing mechanism, but the opening/closing mechanism is not limited thereto. For example, the opening/closing mechanism 44 may be a turnstile, a retractable, or any other type of gate.

The second gate 50 is provided at the exit for the customer HC to exit from the store ST. As illustrated in FIGS. 1 and 2, the second gate 50 includes a second reader 52, an entry detector 53, and an opening/closing mechanism 54. The second reader 52 has the same configuration as the first reader 42. The entry detector 53 has the same configuration as the entry detector 43. The opening/closing mechanism 54 has the same configuration as the opening/closing mechanism 44.

As illustrated in FIG. 1, the first gate 40 includes a communicator 41. The second gate 50 includes a communicator 51. The communicators 41 and 51 each serve as a network interface controller (NIC) for communicating with the detection device 10 via a communication network NW.

The customer HC who enters the store ST via the first gate 40 and exits the store ST via the second gate 50 may purchase products prepared in the store ST. The detection system 1 uses information processing in management of the products in the store ST. Specifically, the products are placed on a shelf SH, such as a shelf SH1 or SH2 in FIG. 2. Hereinafter, the term “shelf SH” refers to a shelf, such as the shelf SH1 or SH2. The shelf SH may be further provided, for example, in a free area FSA in the store ST.

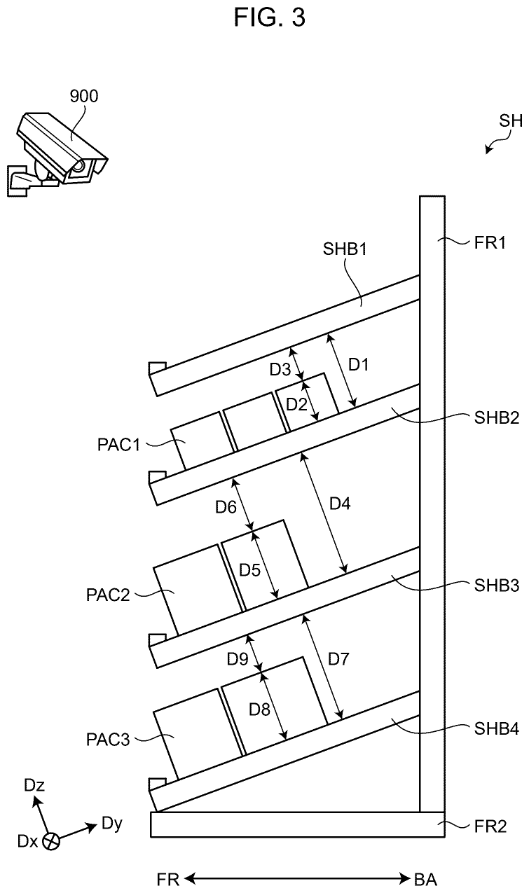

FIG. 3 is a schematic view illustrating a configuration example of the shelf SH. FIGS. 2 and 3 illustrate a front side FR and a back side BA in order to indicate the orientation of the shelf SH. The customer HC can take out the products placed on the shelf SH from the front side FR. A first support FR1 of the shelf SH is provided on the back side BA.

The first support FR1 is a framed wall-like member mounted on a second support FR2. The first support FR1 supports shelf boards with a sensing function SHB, such as shelf boards with a sensing function SHB1, SHB2, SHB3, and SHB4 on the back side BA. Hereinafter, the term “shelf board with a sensing function SHB” refers to a shelf board-like configuration on which products can be placed, such as the shelf boards with a sensing function SHB1, SHB2, SHB3, or SHB4. The second support FR2 is a base-like member that is provided extending from the front side FR to the back side BA and supports the first support FR1.

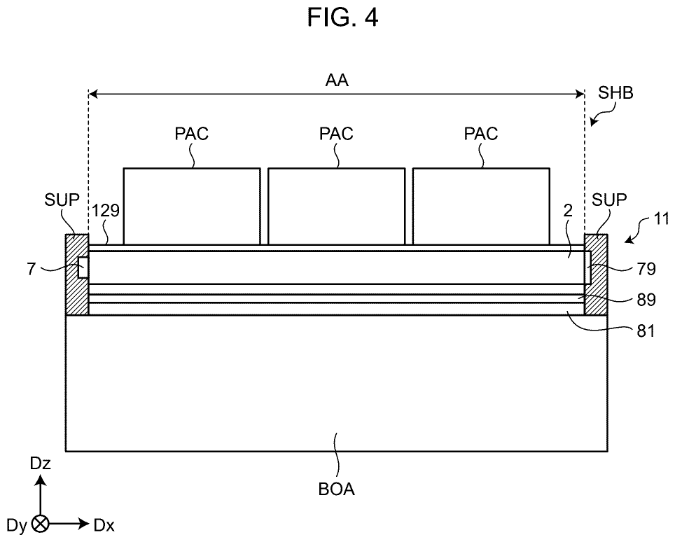

When a floor surface of the store ST on which the second support FR2 is placed is a horizontal surface, the shelf board with a sensing function SHB is inclined downward from the back side BA toward the front side FR with respect to the horizontal surface. A first direction Dx, a second direction Dy, and a third direction Dz are defined with respect to the board surface of the shelf board with a sensing function SHB that is inclined in this way. The first direction Dx and the second direction Dy are two directions along the inclined board surface of the shelf board with a sensing function SHB. The first direction Dx is orthogonal to the second direction Dy. The third direction Dz is a direction orthogonal to the inclined board surface of the shelf board with a sensing function SHB. The tip side of an arrow indicating the third direction Dz indicates a side (upper surface side) of the shelf board with a sensing function SHB on which the products are placed. In FIG. 3, a product PAC1 denotes a product placed on the shelf board with a sensing function SHB2; a product PAC2 denotes a product placed on the shelf board with a sensing function SHB3; and a product PAC3 denotes a product placed on the shelf board with a sensing function SHB4. Hereinafter, the term “product PAC” refers to a product, such as the product PAC1, PAC2, or PAC3. FIG. 4 is a schematic multilayer diagram illustrating a main configuration of the shelf board with a sensing function SHB. The shelf board with a sensing function SHB includes a light source 7, a light guide plate 2, an end member 79, a member 89, a planar optical sensor 81, a shelf board BOA, and a support member SUP. The light source 7 is a light-emitting element that emits light. Specifically, the light source 7 is a light-emitting diode (LED), for example, but is not limited thereto, and may have another configuration for emitting light in response to power supply. The light guide plate 2 is a plate-shaped optical member having a light-transmitting property and a light-scattering property. A plate surface of the light guide plate 2 extends along the first direction Dx and the second direction Dy. The light guide plate 2 directs light from the light source 7 provided on one side of the first direction Dx with respect to the light guide plate 2 to the product PAC. The light guide plate 2 transmits light from the product PAC and guides it toward the member 89. The end member 79 is provided on the opposite side to the light source 7 with the light guide plate 2 interposed therebetween. The end member 79 is an optical member that is adjusted in light reflectance so as to uniformize the light from the light source 7 over the entire plate surfaces of the light guide plate 2. The light source 7 and the end member 79 are located on respective lateral sides of the light guide plate 2 with the light guide plate 2 interposed therebetween.

The member 89 is an optical component interposed between the light guide plate 2 and the planar optical sensor 81. The member 89 limits the traveling direction of light reaching the planar optical sensor 81 from the light guide plate 2. The traveling direction of light limited by the member 89 is defined by a direction of holes provided in the member 89 made of a light-blocking material. For example, the member 89 of the embodiment is a light-blocking member through which microscopic holes penetrate along the third direction Dz. The light emitted from the light source 7 is guided to the product PAC by the light guide plate 2. The light is reflected on a surface on the light guide plate 2 side of the product PAC, passes through the light guide plate 2, and reaches the member 89. Part of the light that has reached the member 89 is blocked by the member 89, and the other part passing through the holes of the member 89 reaches the planar optical sensor 81. A gap is provided between the light guide plate 2 and the member 89 illustrated in FIG. 4, but need not be provided.

The planar optical sensor 81 is a planar optical detector with a plurality of photodetection elements arranged along a Dx-Dy plane. The Dx-Dy plane is a plane along the first direction Dx and the second direction Dy.

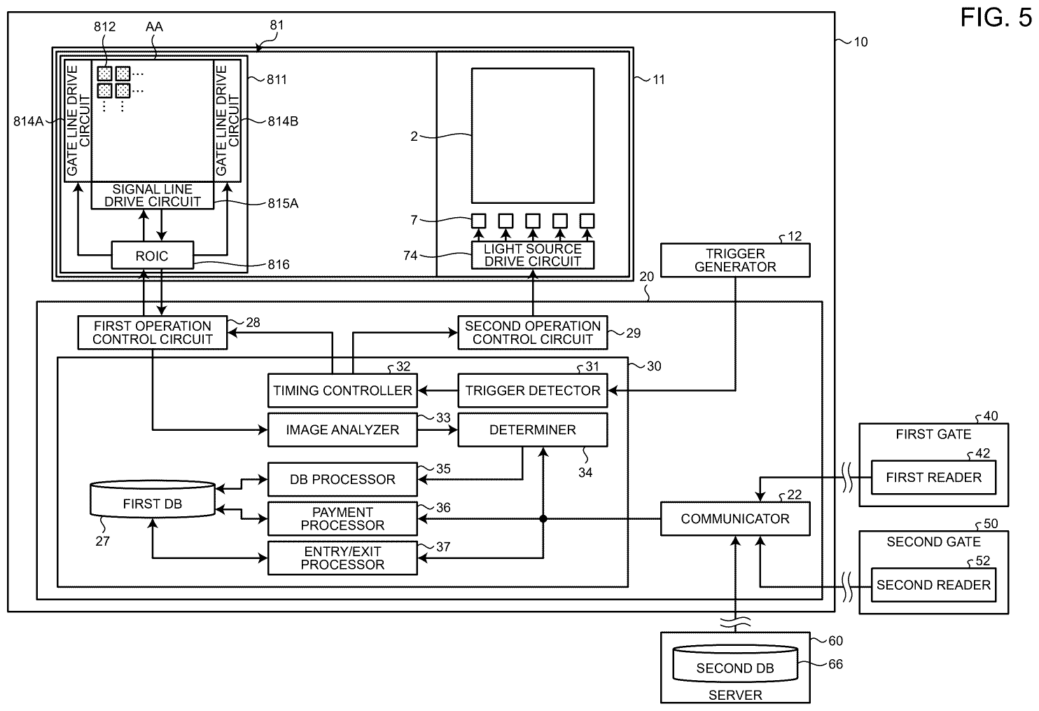

FIG. 5 is a block diagram illustrating a configuration related to an operation of the planar optical sensor 81 and a functional configuration related to the information processing performed based on the light detected by the planar optical sensor 81. The photodetection elements provided in the planar optical sensor 81 are arranged in a matrix having a row-column configuration, for example, as illustrated as photodetection elements 812 in FIG. 5. Each of the photodetection elements is a photodiode formed on a substrate 811, for example, but is not limited thereto, and may be another photodetection element. The sensing area AA indicates an area in which a plurality of photodetection elements, such as the photodetection elements 812, are arranged in the planar optical sensor 81. The planar optical sensor 81 serves as a planar optical sensor that detects light in the sensing area AA. The sensing area AA of the planar optical sensor 81 faces the member 89. As described with reference to FIG. 4, the light reaching the planar optical sensor 81 is the light reflected on the surface of the product PAC facing the light guide plate 2. That is, the light detection by the planar optical sensor 81 can detect the product PAC placed in the sensing area AA of the shelf board with a sensing function SHB.

The substrate 811 is the substrate of the planar optical sensor 81. Gate line drive circuits 814A and 814B, a signal line drive circuit 815A, and a readout integrated circuit (ROIC) 816 are further mounted on the substrate 811. The gate line drive circuits 814A and 814B are gate drivers that provide gate drive signals to the gates of the photodetection elements 812. The gate line drive circuits 814A and 814B are coupled to the photodetection elements 812 via gate lines (not illustrated). The signal line drive circuit 815A is a source driver that transmits outputs from the photodetection elements 812 to the ROIC 816. The signal line drive circuit 815A is coupled to the photodetection elements 812 via signal lines (not illustrated). The photodetection elements 812 output signals corresponding to degrees of light detection to the signal lines at the time when the drive signals are received from the gate driver. The outputs are output to the detection device 10 via the signal line drive circuit 815A and the ROIC 816. The ROIC 816 is a readout integrated circuit. The ROIC 816 controls operations of the gate driver and the source driver to read out signals indicating the degrees of light detection by the photodetection elements 812. The ROIC 816 also controls the operations of the gate driver and the source driver related to reset operations of the photodetection elements 812.

The shelf board BOA in FIG. 4 is a plate-like member. The support member SUP supports the light source 7, the member 89, and the planar optical sensor 81 on the upper surface side of the shelf board BOA. The support member SUP has, for example, a frame-like shape that surrounds the sensing area AA when viewed from a planar viewpoint, but may be members that cover two sides facing each other in the first direction Dx with the sensing area AA interposed therebetween.

The shelf boards with a sensing function SHB1, SHB2, SHB3, or SHB4 illustrated in FIG. 3 are each the shelf board with a sensing function SHB. Therefore, the shelf SH is provided with a plurality of the shelf boards with a sensing function SHB. The light source 7, the light guide plate 2, and the planar optical sensor 81 illustrated in FIG. 4 are included in a sensor 11 of the detection device 10 illustrated in FIG. 1. Therefore, one shelf board with a sensing function SHB includes one sensor 11. That is, the shelf SH includes a plurality of the sensors 11. In FIG. 1, the detection device 10 includes one block of the sensor 11, but this illustration does not intend to limit the number of the sensors 11 included in the detection device 10 to one. A plurality of the sensors 11 may be provided in the same way as the shelf SH. The configuration of the detection device 10 may include an even larger number of the sensors 11 by providing a plurality of the shelves SH, such as the shelves SH1 and SH2.

In FIG. 4, an interposed portion 129 is further provided between the light guide plate 2 and the product PAC. The interposed portion 129 is, for example, a light-transmitting protective film for the light guide plate 2, but a weight sensor 125, to be described below, may be provided at the location of the interposed portion 129. In the embodiment, a surface of the interposed portion 129 facing the product PAC serves as a placement surface of the shelf board with a sensing function SHB on which the product PAC is placed.

As described above, the light source 7, the light guide plate 2, and the planar optical sensor 81 illustrated in FIG. 4 are included in the sensor 11 of the detection device 10 illustrated in FIG. 1. The detection device 10 illustrated in FIG. 1 includes the sensor 11, a trigger generator 12, and an information processor 20. The trigger generator 12 generates an output that serves as a trigger to operate the sensor 11. Details of the trigger generator 12 will be described later.

As illustrated in FIG. 1, the information processor 20 includes an arithmetic unit (arithmetic circuit) 21, a communicator 22, an input device 23, an output device 24, and a storage 25. The arithmetic unit 21 includes an arithmetic circuit that serves as a central processing unit (CPU), and reads computer software programs, such as an information processing computer program 26, stored in the storage 25 and data to be referred to for executing the computer software programs (hereinafter, referred to as computer programs and the like), and executes processing of computer programs and the like.

The communicator 22 serves as a NIC to communicate with the first gate 40, the second gate 50, the server 60, and the terminal device 90 via the communication network NW. The input device 23 includes one or more input devices, such as a keyboard, a mouse, a touch panel, and the like, and receives input operations from an administrator of the information processor 20. The output device 24 includes one or more of output devices, such as a display, a speaker, a printer, and the like, and performs output according to processing details of the arithmetic unit 21.

The storage 25 includes storage devices, such as a hard disk drive (HDD), a solid-state drive (SSD), and the like, and stores therein various computer programs and the like. FIG. 1 illustrates the information processing computer program 26 and a first DB 27, as the computer programs and the like stored by the storage 25. The term “DB” in the first DB 27 and a second DB to be described later refers to a database.

The arithmetic unit 21 executes the information processing computer program 26 stored in the storage 25 to cause a processor 30 illustrated in FIG. 5 to function. The processor 30 functions as a trigger detector 31, a timing controller 32, an image analyzer 33, a determiner 34, a DB processor 35, a payment processor 36, and an entry/exit processor 37. When functioning as the DB processor 35, the payment processor 36, and the entry/exit processor 37, the processor 30 refers to the first DB 27.

As illustrated in FIG. 5, the information processor 20 further includes a first operation control circuit 28 and a second operation control circuit 29. The first operation control circuit 28 and the second operation control circuit 29 are circuits that operate under the control of the timing controller 32. The first operation control circuit 28 outputs commands for operating the planar optical sensor 81 to the ROIC 816. The second operation control circuit 29 outputs commands for operating the light source 7 to a light source drive circuit 74. The light source drive circuit 74 is a circuit that controls the lighting of the light source 7. For example, when the light source 7 is an LED, the light source drive circuit 74 is an LED driver. The light source 7 is turned on or off under the control of the light source drive circuit 74.

When the sensor 11 operates, the light source 7 is turned on and the planar optical sensor 81 detects the light. An output corresponding to the degrees of light detection by the planar optical sensor 81 is then output to the information processor 20 via the signal line drive circuit 815A and ROIC 816. Hereinafter, the term “sensing” refers to the operation of the sensor 11 that produces the output, unless otherwise noted.

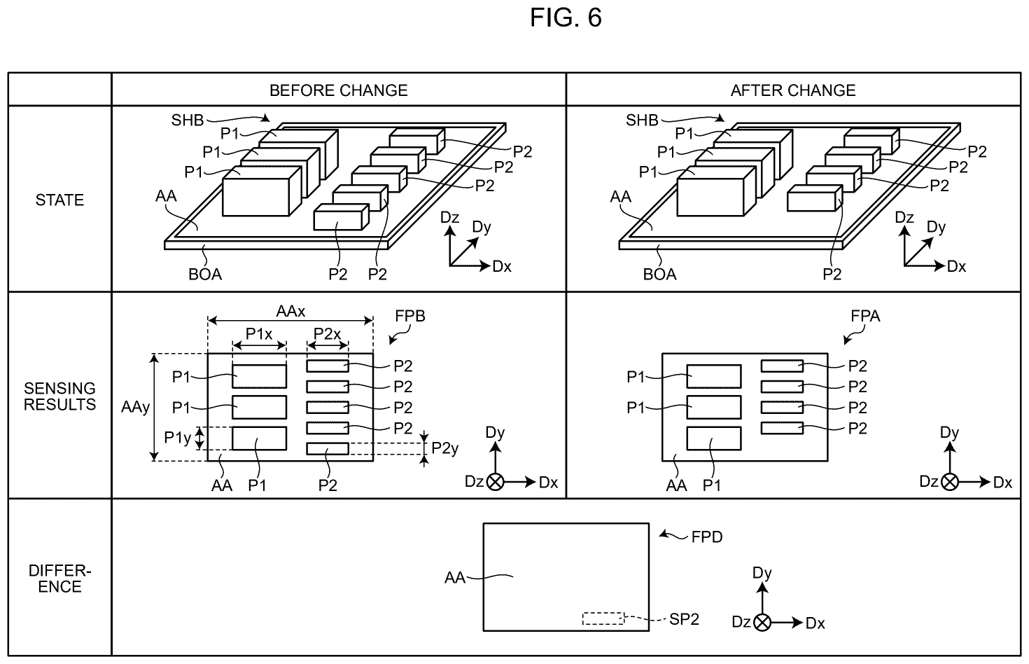

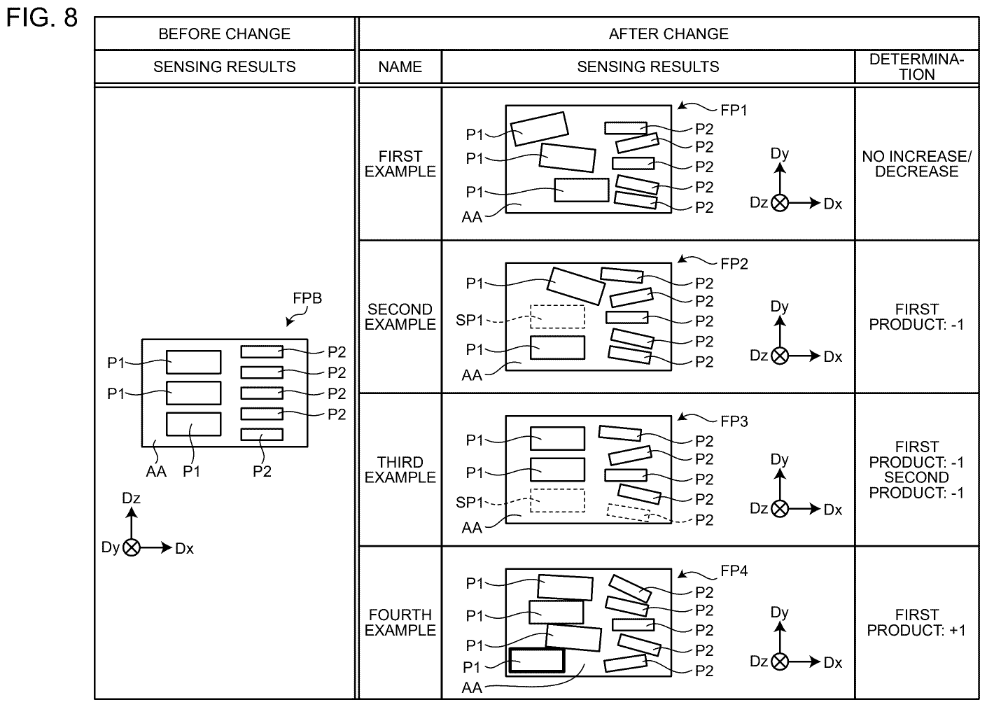

As described above, the information processing by the detection system 1 (refer to FIG. 1) is used in the management of the products in the store ST (refer to FIG. 2). Specifically, the operations of the sensor 11 are involved in the detection of the products such as the product PAC on the shelf board with a sensing function SHB (refer to FIG. 4) provided on the shelf SH (refer to FIG. 3). The following describes the detection of the products by the operations of the sensor 11 with reference to FIGS. 6 and 8.

FIG. 6 is a schematic diagram illustrating exemplary states of the shelf board with a sensing function SHB and the products on the shelf board with a sensing function SHB before and after the number of the placed products changes. In the example illustrated in FIG. 6, products placed in the sensing area AA of the shelf board with a sensing function SHB are illustrated as products P1 and P2.

The products P1 and P2 are each an example of the product PAC. The products P1 and P2 are both products packaged in cuboid packages but have different dimensions. Specifically, when the longest side of each of the products P1 and P2 is placed along the first direction Dx, a length P1x of the product P1 in the first direction Dx is longer than a length P2x of the product P2 in the first direction Dx. In this case, for each of two sides other than the longest side, the length of the side of the product P1 is longer than the length of the side of the product P2. FIG. 6 indicates that a length P1y of the product P1 in the second direction Dy is longer than a length P2y of the product P2 in the second direction Dy.

As illustrated in FIG. 6, a length AAx in the first direction Dx and a length AAy in the second direction Dy of the sensing area AA are significantly longer than the lengths P1x, P1y, P2x, and P2y. That is, the sensing area AA serving as a sensing area of the planar optical sensor 81 of the embodiment has a sufficient area where a plurality of the products PAC can be placed.

In the “before change” column of FIG. 6, the “state” row indicates that the three products P1 and the five products P2 are placed in the sensing area AA. As described with reference to FIG. 4, by the detection of the light by the planar optical sensor 81, the products PAC such as the products P1 and P2 placed in the sensing area AA of the shelf board with a sensing function SHB can be detected. Therefore, when the sensing is performed in the “state” “before change”, the sensor 11 produces an output corresponding to a state in which the three products P1 and the five products P2 are placed in the sensing area AA, as illustrated in the “sensing result” row of the “before change” column.

In contrast, in the “after change” column of FIG. 6, the “state” row indicates that three products P1 and four products P2 are placed in the sensing area AA. When the sensing is performed in the “state” “after change”, the sensor 11 produces an output corresponding to a state in which the three products P1 and the four products P2 are placed in the sensing area AA, as illustrated in the “sensing result” row of the “after change” column. The term “change” in the expressions “before change” and “after change” herein refers to a change in state (for example, decrease in number) of the products placed on the shelf board with a sensing function SHB. The change in state of the products is indicated as a result of the sensing and thereby can be detected by the processor 30.

“After change” in FIG. 6, the number of the products P2 has been reduced by one from “before change”. This result is also indicated in the output of the sensor 11 illustrated in the “sensing result” row. Therefore, comparing the output corresponding to the “sensing result” “before change” with the output corresponding to the “sensing result” “after change,” a difference corresponding to the decrease in the number of the products P2 is detected. In the “difference” row of FIG. 6, an area corresponding to the product P2 placed in sensing area AA “before change” but no longer placed in the sensing area AA “after change” is illustrated as a dashed-line rectangle SP2.

The description with reference to FIG. 6 illustrates an example in which the dashed-line rectangle SP2 can be extracted as a simple image difference, but the location of each of the products PAC, such as the products P1 and P2, placed in the sensing area AA is variable. Therefore, the embodiment provides a mechanism to determine the types of the products PAC and the number of each of the types of the products PAC regardless of the location of each of the products PAC, and make a comparative determination between before and after the change.

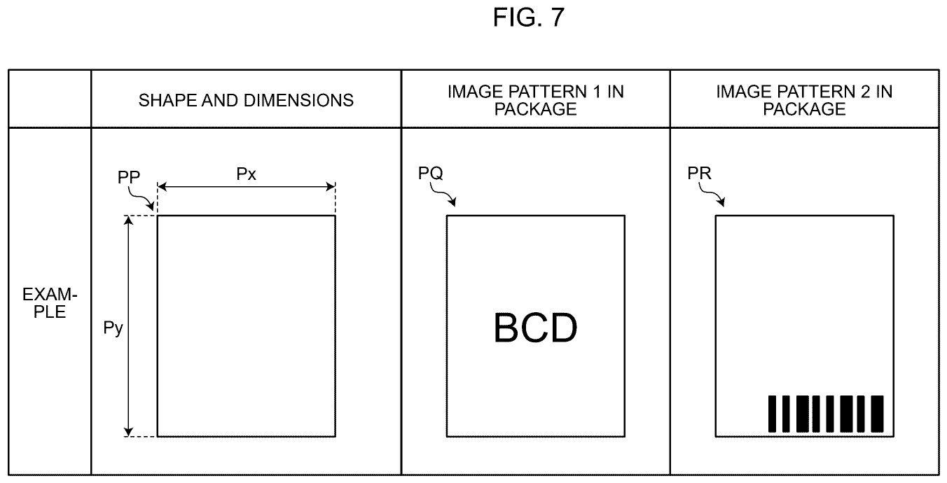

FIG. 7 illustrates a schematic diagram illustrating methods for identifying the products PAC. Products PP, PQ, and PR illustrated in FIG. 7 are different types of the products PAC. When a plurality of types of the products PAC are mixed in the sensing area AA, examples of the methods for identifying the various types of the products PAC include, but are not limited to, a method based on the shape and/or dimensions of one surface of the product PAC facing the sensing area AA on one surface of the product PAC facing the sensing area AA and a method based on an image pattern on the one surface of the product PAC facing the sensing area AA.

For example, a method can be used to identify the product PAC based on the shape of the one surface of the product PAC facing the sensing area AA when viewed from a planar viewpoint and/or the dimensions of the shape. The products PAC having different shapes when viewed from the planar viewpoint can be identified as different types of the products PAC. Even if a plurality of types of the products PAC have the same type of shape, the type of the product PAC can be identified based on the dimension (length) of the longest one side of the shape when viewed from the planar viewpoint and the dimension (length) in a direction orthogonal to the dimension of the one side. In “example” in the “shape and dimensions” column of FIG. 7, a length Py of the product PP is the dimension of the one side, and a length Px of the product PP is the dimension in the direction orthogonal to the dimension of the one side. The products P1 and P2 described with reference to FIG. 6 are both rectangular in shape when viewed from the planar viewpoint, but are identified by a difference between the lengths P1y and P2y corresponding to the dimensions of the longest sides and a difference between the lengths P1x and P2x corresponding to the dimensions in the direction orthogonal to the dimensions of the longest sides.

Another method can be used to identify the product PAC based on the image pattern on one surface of the product PAC facing the sensing area AA. The products PAC having different image patterns can be identified as different types of the products PAC. FIG. 7 illustrates, in “example”, an example in which a character string “BCD” characterizes the image pattern for the product PQ, as “image pattern 1 in package”. FIG. 7 also illustrates an example in which a sequence of one-dimensional barcode-like rectangles characterizes the image pattern for the product PR, as “image pattern 2 in package”. With the differences in image pattern, such as the differences in characteristics in “image pattern 1 in package” and “image pattern 2 in package”, the product PQ and the product PR are identified.

In the identification of the product PAC, when the product can be identified with at least one of the shape, the dimensions, and the characteristics of the image pattern, the process related to identification may be completed using the at least one item and not using the other items. Therefore, for the products identifiable by one of the above-mentioned items (shape, dimension, and image pattern), the identification process may be performed only with the one item without performing identification process with the other items. However, a combination of more than one of the items increases the accuracy of the identification, the identification process may be performed based on the combination.

As described with reference to FIG. 7, the planar optical sensor 81 has a resolution capable of identifying the shape of one surface which faces the planar optical sensor 81, of each of the products PAC placed on the shelf board with a sensing function SHB and also identifying characters, identifiers, and patterns marked on the one surface. The resolution is given by the photodetection elements provided in the planar optical sensor 81. To give a specific example, the resolution is given by the photodetection elements 812 arranged in a matrix having a row-column configuration, as described with reference to FIG. 5. The term “identifier” herein refers to a barcode as illustrated in “image pattern 2 in package”, for example. The examples of the “identifier” herein also include other identifiers, such as two-dimensional codes, not illustrated in FIG. 7. Even patterns that are not supposed to serve as identifiers can be used as image patterns for identification of products.

In the embodiment, image patterns on surfaces of the products PAC facing the sensing area AA are first extracted by comparing the image patterns with a blank image pattern in a state in which nothing is placed in the sensing area AA. Then, each of the image patterns is identified as to which type of the product PAC is indicated by the image pattern, based on the shape and the dimensions of the extracted image pattern and the characteristics included in the image pattern. By performing such identification, the products PAC of each type can be counted after identifying the same type of the products PAC, even if the orientations of the same type of the products PAC placed in the sensing area AA differ from one another. In addition, the products PAC of each type can be individually counted after identifying the different types of the products PAC.

FIG. 8 is a schematic diagram illustrating exemplary cases where arrangements of some or all of the products PAC in the sensing area AA do not match between before and after a change. Even if, as a result of the identification of the products PAC with reference to FIG. 7, the arrangements of some or all of the products PAC in the sensing area AA do not match between before and after the change, changes in the products PAC placed in the sensing area AA can be detected after determining the types of the products PAC and the number of the products PAC of each of the types.

The number of the products P1 and the number of the products P2 in the sensing area AA indicated by the “sensing result” “before change” in FIG. 8 are the same as those indicated by the “sensing result” “before change” described with reference to FIG. 6. In the “first example” of the “sensing result” of “after change” in FIG. 8, the number of the products P1 and the number of the products P2 in the sensing area AA have not changed from those in the “sensing result” “before change”, but the arrangement of the products P1 and P2 has changed. However, even though the arrangement of the products P1 and P2 is identified to have changed as a result of the identification of the products PAC described with reference to FIG. 7, the number of the products P1 and the number of the products P2 in the sensing area AA can be detected to have not changed, in the embodiment.

In the “second example”, the “third example”, and the “fourth example” of the “sensing result” of “after change” in FIG. 8, not only the arrangement of the products P1 and P2 has changed, but also at least one of the number of the products P1 and the number of the products P2 has changed. Specifically, in the “second example”, the number of the products P1 has decreased by one from “before change”. In the “third example”, the number of the products P1 and the number of the products P2 have each decreased by one from “before change”. In the “fourth example”, the number of the products P1 has increased by one from “before change”. Also, for these examples, the changes in numbers can be detected by the identification of the products PAC described with reference to FIG. 7.

The image analyzer 33 of the processor 30 illustrated in FIG. 5 performs the identification of the types and the numbers of the products PAC as described with reference to FIGS. 6 to 8. Then, the determiner 34 compares the sensing results before and after the change and detects the changes in types and numbers of the products PAC placed in the sensing area AA.

From among the sensing results before and after the change, the sensing result after the change is acquired when the trigger detector 31 of the processor 30 has detected a trigger output from the trigger generator 12. FIG. 1 illustrates an imager 121 and the weight sensor 125 as components of the trigger generator 12.

As illustrated in FIG. 2, the imager 121 is an imaging device provided such that a product movement detection region CA is within an imaging region, and captures a moving image therein. The product movement detection region CA is a region on the front side FR of the shelf SH, such as the shelf SH1 or SH2. The imager 121 includes an imaging device, such as a complementary metal-oxide-semiconductor (CMOS) image sensor, and outputs moving image data by periodically outputting light detected by the image sensor as image data. In the example illustrated in FIG. 2, the customer HC2 has entered the product movement detection region CA on the front side FR of the shelf SH1. When the imager 121 captures an image of any of the products PAC in the product movement detection region CA, the captured image data output from the imager 121 is regarded as the trigger. More specifically, the trigger detector 31 illustrated in FIG. 5 performs pattern matching between the captured image data output from the imager 121 and the image data of the product PAC prepared in advance, and regards the captured image data as the trigger if the captured image data is determined to include the image data of the product PAC.

When the trigger detector 31 illustrated in FIG. 5 has detected the trigger, the trigger detector 31 operates the timing controller 32. The timing controller 32 controls the operation timing of the first operation control circuit 28 and the second operation control circuit 29 under the control of the trigger detector 31. When the timing controller 32 operates, the light source 7 is turned on under the control of the second operation control circuit 29, and the planar optical sensor 81 functions as the planar optical sensor under the control of the first operation control circuit 28 to perform sensing in the sensing area AA. The sensing data obtained as a result of the sensing is output to the image analyzer 33. The image analyzer 33 identifies the type and the number of the products PAC as described with reference to FIGS. 6 to 8. Then, the determiner 34 compares the sensing results before and after the change and detects the changes in types and numbers of the products PAC placed in the sensing area AA. A no-entry portion DS in FIG. 2 is an object (obstacle) to prevent the customers HC from entering a lateral side of the shelf SH. The imager 121 may be further additionally provided to add the product movement detection region CA to an area where the no-entry portion DS is provided.

While the case where the output of the imager 121 is regarded as the trigger has been described above, an output of the weight sensor 125 may be regarded as the trigger. When the weight sensor 125 is employed, the weight sensor 125 is provided on the shelf SH described with reference to FIG. 3. The weight sensor 125 is provided, for example, between the second support FR2 and the floor of the store ST and detects changes in weight of the shelf SH. The weight of the shelf SH changes when the product PAC placed on the shelf SH is taken out or the product PAC is additionally placed on the shelf SH. The change in weight is detected by the weight sensor 125. The weight sensor 125 produces an output indicating that the change in weight has been detected. The output is regarded as the trigger by the trigger detector 31. Therefore, the same process is performed as in the case where the image data captured by the imager 121 is regarded as the trigger.

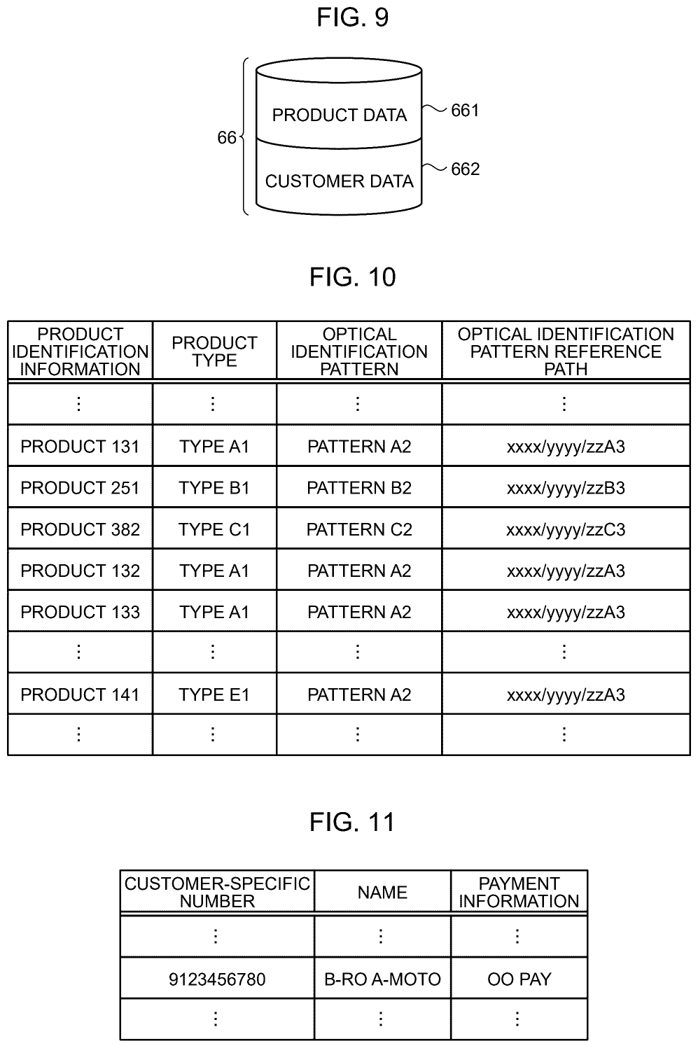

If the determiner 34 determines that a change has occurred in the types and numbers of the products PAC placed in the sensing area AA, the DB processor 35 illustrated in FIG. 5 accesses the first DB 27. The following describes the details of data managed in the first DB 27 and a second DB 66 of the server 60, with reference to FIGS. 9 to 14.

FIG. 9 is a schematic diagram illustrating a configuration of the second DB 66. The second DB 66 includes product data 661 and customer data 662. The server 60 that serves as the second DB 66 is an information processing device that is provided so as to be capable of communicating with the detection device 10 via the communication network NW. An arithmetic unit (arithmetic circuit) 61 has the same configuration as the arithmetic unit 21. A communicator 62 has the same configuration as the communicator 22. An input device 63 has the same configuration as the input device 23. An output device 64 has the same configuration as the output device 24. A storage 65 has the same configuration as the storage 25, but stores different data from that of the storage 25. The storage 65 stores therein computer programs to serve as the second DB 66, other programs, and data.

FIG. 10 is a table illustrating exemplary content of the product data 661. The product data 661 is data in a table form having columns: “product identification information”, “product type”, “optical identification pattern”, “optical identification pattern reference path”, and so forth. Data of products handled in a plurality of the stores ST sharing the server 60 is registered in the product data 661. One record (row) of the product data 661 is set for one product.

The field (cell) for the product identification information is a field in which a unique character string indicating each of the products is set. For example, “product 131” and “product 251” are unique character strings indicating different products. The same applies to other character strings set in the field for the product identification information.

The field for the product type is a field in which information indicating the type of a product is set. For example, “type A1”, “type B1”, “type C1”, and “type E1” indicate different types of products. “Type A1” is set in a field for the product type of a record in which “product 131”, “product 132”, or “product 133” is set in the field for the product identification information. This setting indicates that “product 131”, “product 132”, and “product 133” are products of the same type.

The field for the optical identification pattern is a field in which a character string indicating a name given to the optical identification pattern corresponding to the type of the product PAC is set. The field for the optical identification pattern reference path is a field in which a file path indicating a storing location of the optical identification pattern data is set, wherein the optical identification pattern data is data having the name that is set in the field for the optical identification pattern as described above. The file path indicates a storage area in the storage 65 of the server 60. That is, the data (optical identification pattern) indicated by the file path is stored in the storage 65. It is determined that the data of an “image pattern of a certain type of product PAC” included in the sensing results matches the data of the “certain type” of optical identification pattern, in terms of pattern matching. As a specific example, assume a case where the product PAC of the “type Al” has been sensed in the sensing area AA. In this case, in the identification of the products by the image analyzer 33, it is determined that the image pattern included in the sensing results matches the optical identification pattern data obtained by referring to the optical identification pattern path of a record where the product type is the “type Al” among the records of the product data 661 illustrated in FIG. 10.

FIG. 11 is a table illustrating exemplary content of the customer data 662. The customer data 662 is data in table form having columns: “customer-specific number”, “name”, and “payment information”. One record of the customer data 662 is set for one customer HC.

The field for the customer-specific number is a field in which a unique number assigned to each of the customers HC is set. That is, the number (customer-specific number) set in the field for the customer-specific number is different for each of the customers HC. In the embodiment, the customer-specific number corresponds to the identification information held by the identification information holder 99. The field for the name is a field in which a character string indicating the name of the customer HC is set. The field for the payment information is a field in which information indicating a service used by the customer HC to make a settlement (payment) for a product is set.

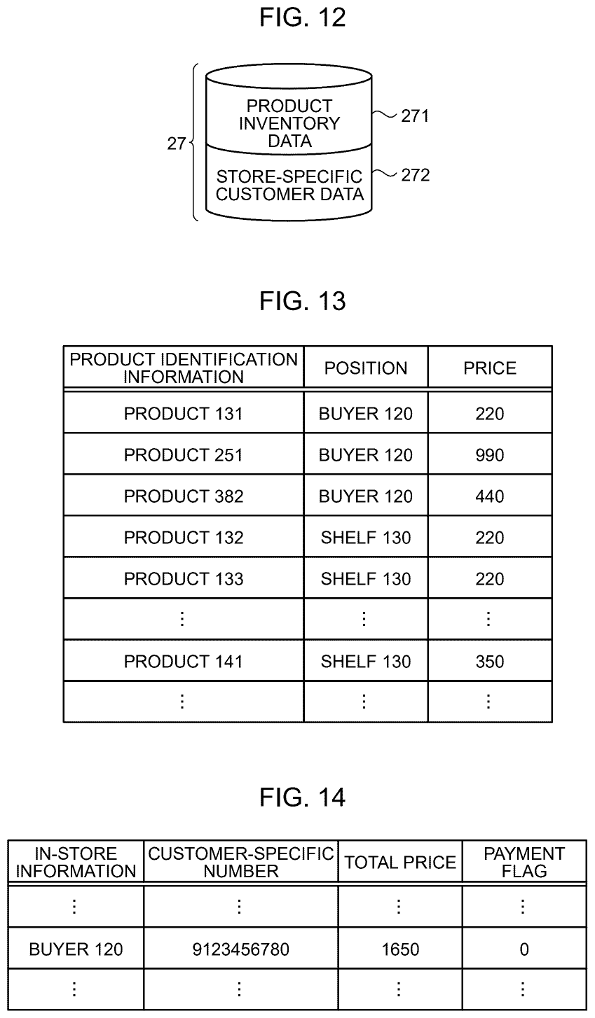

FIG. 12 is a diagram illustrating a configuration of the first DB 27. The first DB 27 includes product inventory data 271 and store-specific customer data 272. The second DB 66 described with reference to FIGS. 9 to 11 contains data referred to by the detection devices 10 of the stores ST sharing the server 60. In contrast to this, the first DB 27 contains data necessary to manage the products handled by the detection device 10 in one store ST.

FIG. 13 is a table illustrating exemplary content of the product inventory data 271. The product inventory data 271 is data in table form having columns: the “product identification information”, “position”, and “price”. One record (row) of the product inventory data 271 is set for one product.

The field for the product identification information is a field in which a unique character string indicating each of the products is set. If the character string set in the field for the product identification information on the product data 661 described with reference to FIG. 10 is the same as the character string set in the field for the product identification information on the product inventory data 271 illustrated in FIG. 13, the product PAC managed in the record of the product data 661 is the same as the product PAC managed in the record of the product inventory data 271.

The field for position is a field in which information indicating the current position of each of the products is set. For example, when “buyer 120” is set in the field for position of a record, the record indicates that the product PAC of the record is held by the customer HC managed as the “buyer 120”. When “shelf 130” is set in the field for position of a record, the record indicates that the product PAC of the record is placed on the shelf SH managed as the “shelf 130”. Among character strings set in the field for position, a character string indicating the particular customer HC corresponds to a character string set in a field for in-store information in the customer data 662 to be described later.

The field for price is a field in which a numerical value indicating a price of each of the products is set. For example, when “220” is set in the field for price of a record, the record indicates that an amount to be charged at the time of payment for the product PAC of the record is 220 yen. The currency unit of the numerical value can be changed as appropriate.

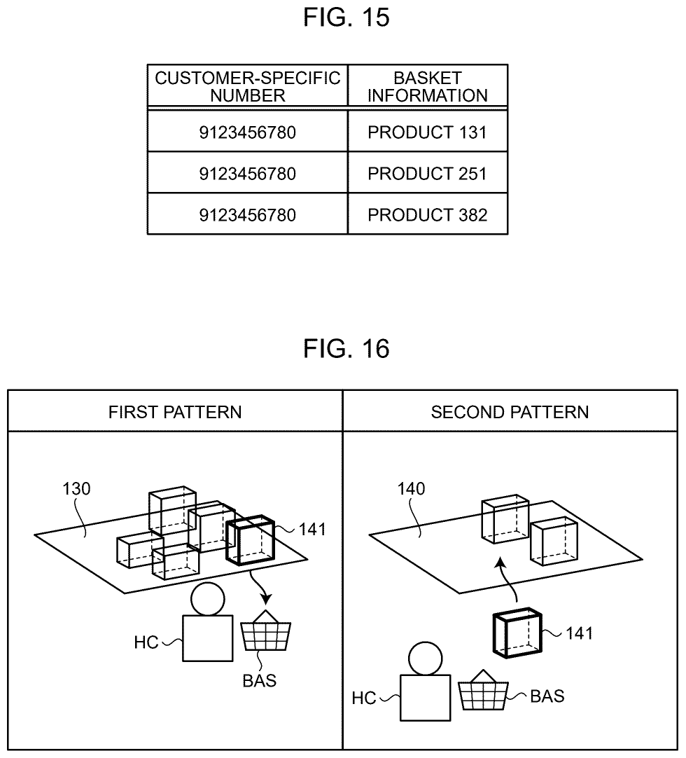

FIG. 14 is a table illustrating exemplary content of the store-specific customer data 272. The store-specific customer data 272 is data in table form having columns: the “in-store information”, the “customer-specific number”, “total price”, and “payment flag”. One record of the store-specific customer data 272 is set for one customer HC.

The field for in-store information is a field in which a unique character string that is assigned to each of the customers HC and managed in one store ST is set. The field for customer-specific number is a field in which the unique number assigned to each of the customers HC is set. If the number set in the field for customer-specific number of the product data 661 described with reference to FIG. 10 is the same as the number set in the field for customer-specific number of the product inventory data 271 illustrated in FIG. 13, the customer HC managed by the record of the product data 661 is the same as the customer HC managed by the record of the product inventory data 271. That is, the customer data 662 is a database for managing the customer HC by assigning, to the customer HC, the character string for the “in-store information” unique to each store ST.

The field for total price is a field in which a numerical value indicating a price charged for payment for the product PAC held by the customer HC managed by each record of the customer data 662 is set. When the character string set in the field for position in the record of the product data 661 is a character string indicating the customer HC, the price in the record of the product data 661 correlates with the total price in the record of the customer data 662. For example, in the example illustrated in FIG. 13, a character string “buyer 120” is set in the fields for position in three records. The numerical values in the field for price included in the three records are 220, 990, and 440. The total of the three numerical values is 1650. In the example illustrated in FIG. 14, a numerical value of 1650 is set in the field for total price of the record in which the character string “buyer 120” is set in the field for in-store information. Thus, the numerical value set in the field for total price of a record corresponds to the total price of the products held by the customer HC managed by that record.

The field for payment flag is a field in which a flag value indicating whether the payment for the product held by the customer HC has been completed is set. The flag value can be a binary value of 0 or 1, for example. The flag value of 0 indicates that the payment has not been completed. The flag value of 1 indicates that the payment has been completed. The payment status indicated by each flag value may be reversed. The point is that the payment status for the product can be indicated by the flag value. While the information managed by the second DB 66 and the first DB 27 has been described above, other information may be used in the information processing by the detection system 1. For example, data (buyer data) may be further used that is generated by execution of an information processing computer program 96 stored in a storage 95 by an arithmetic circuit 91 of the terminal device 90 individually owned and used by each of the customers HC.

FIG. 15 is a table illustrating exemplary content of the buyer data. The buyer data is data in table form having columns of the “customer-specific number” and “basket information”.

The field for customer-specific number is a field in which the number unique to the customer HC who owns the terminal device 90 storing therein the buyer data is set. If the number set in the field for customer-specific number in the product data 661 described with reference to FIG. 10, the number set in the field for customer-specific number in the product inventory data 271 described with reference to FIG. 13, and the number set in the field for customer-specific number in the buyer data illustrated in FIG. 15 are the same, the customer HC managed by these records is the same.

The field for basket information is a field in which a character string indicating a product held by the customer HC who owns the terminal device 90 storing therein the buyer data is set. If the character string set in the product identification information in the product inventory data 271 described with reference to FIG. 13 is the same as the character string set in the field for basket information of the buyer data illustrated in FIG. 15, the product PAC managed by these records is the same. The information on the product PAC managed by the record of the buyer data corresponds to the information set in the field for position of the product PAC managed by the record of the product inventory data 271 described with reference to FIG. 13. For example, in the example illustrated in FIG. 13, the character string “buyer 120” is set in the fields for position in three records. Character strings “product 131”, “product 251”, and “product 382” are set in the fields for product identification information included in these three records. These character strings correspond to the character strings set in the fields for basket information in the three records included in the buyer data illustrated in FIG. 15. Furthermore, the number set in the field for customer-specific number in the buyer data illustrated in FIG. 15 is “9123456780”. In the store-specific customer data 272 described with reference to FIG. 14A, character string of “buyer 120” is set in the field for in-store information included in the record having the number of “9123456780” set as the customer-specific number. Thus, the buyer data correlates with the product inventory data 271 and the store-specific customer data 272.

The terminal device 90 is a small information processing device, such as a smartphone, that can be carried around by the customer HC. The arithmetic circuit 91 is configured as a circuit, such as a system-on-chip, that has a function to perform arithmetic processing. A communicator 92 functions in the same way as the communicator 22. While FIG. 1 separately illustrates the arithmetic circuit 91 and the communicator 92, a portion that serves as the communicator 92 may be integrally packaged in the arithmetic circuit 91 or may be configured as an independent circuit. An input device 93 and an output device 94 have a configuration in which a display output function is integrated with an input receiving function, for example, in the same way as a touchscreen display. The display output function is a function according to the processing of the arithmetic circuit 91, and the input receiving function is a function that allows touch operations on a display output, for example. However, the specific configuration of the input device 93 and the output device 94 may be changed as appropriate. The storage 95 is functionally the same as the storage 25 but is generally configured as a flash memory. The identification information holder 99 is as described above.

The following describes cases where the position of the product PAC placed on the shelf SH is moved by the customer HC, with reference to FIGS. 16 to 20.

FIG. 16 is a schematic diagram illustrating exemplary cases where the position of the product PAC placed on the shelf SH is moved by the customer HC. A “first pattern” illustrated in FIG. 16 indicates a case where the customer HC takes a product 141 off the shelf 130 and holds it. A basket BAS is a hand-held basket for the customer HC to hold the product PAC. The product 141 is the product PAC with the character string “product 141” set in the field for product identification information in the product inventory data 271 described with reference to FIG. 13. The shelf 130 is the shelf board with a sensing function SHB provided on the shelf SH at the position “shelf 130” that is set in the field for position in the product inventory data 271. The customer HC illustrated in FIG. 16 is assumed to be the customer HC corresponding to the character string “buyer 120” that is set in the field for in-store information.

A “second pattern” illustrated in FIG. 16 indicates a case where the product 141 held by the customer HC in the “first pattern” is placed on the shelf 140. The shelf 140 is the shelf board with a sensing function SHB provided on the shelf SH at the position “shelf 140” that is set in the field for position in the product inventory data 271.

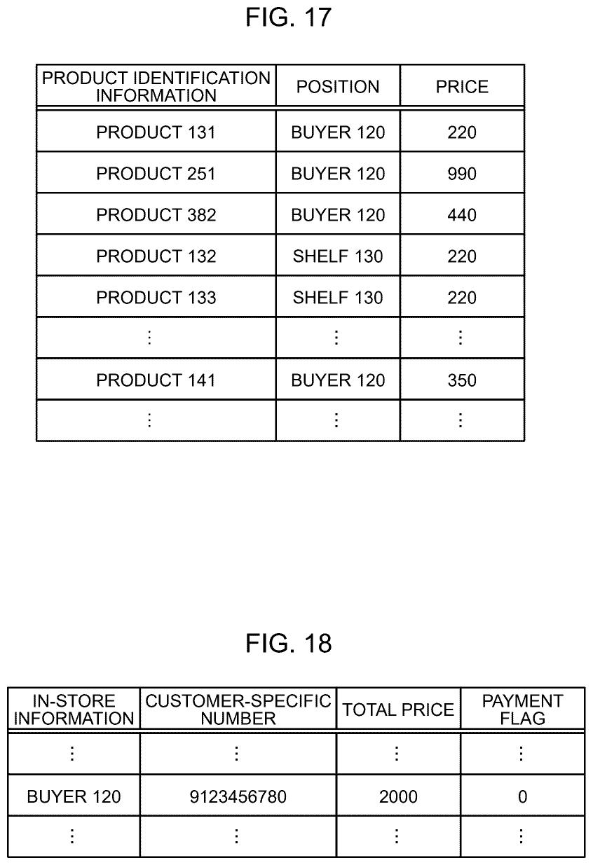

The following describes updating of information in the case of occurrence of each of the “first pattern” and the “second pattern” illustrated in FIG. 16, with reference to FIGS. 17 to 20. First, the updating of information in the case of the occurrence of the “first pattern” will be described with reference to FIGS. 17 to 19. The content of the second DB 66 before the occurrence of the “first pattern” is assumed to be as illustrated in FIGS. 13 and 14. The content of the buyer data before the occurrence of the “first pattern” is assumed to be as illustrated in FIG. 15.

FIG. 17 is a table illustrating exemplary content of the product inventory data 271 after the occurrence of the “first pattern”. In the product inventory data 271 before the occurrence of the “first pattern”, the “position” of the record in which the product identification information is the “product 141” is the “shelf 130”, as illustrated in FIG. 13. In contrast to this, in the product inventory data 271 after the occurrence of the “first pattern”, the “position” of the record in which the product identification information is the “product 141” is the “buyer 120”, as illustrated in FIG. 17.

FIG. 18 is a table illustrating exemplary content of the store-specific customer data 272 after the occurrence of the “first pattern”. After the occurrence of the “first pattern”, the customer HC holds the product 141 with the price “350” set in the field for price, so that the value of 350 is added to the field for total price in the record for the customer HC. Specifically, in the store-specific customer data 272 before the occurrence of the “first pattern”, the “total price” in that record is “1650”, as illustrated in FIG. 14. In contrast, in the store-specific customer data 272 after the occurrence of the “first pattern”, the “total price” in that record is “2000”, as illustrated in FIG. 18.

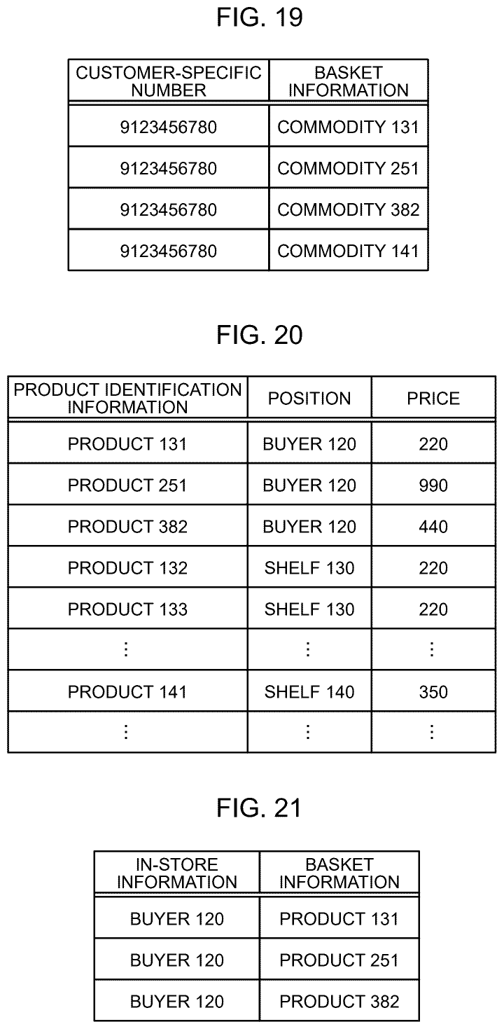

FIG. 19 is a table illustrating exemplary content of the buyer data after the occurrence of the “first pattern”. As illustrated in FIG. 15, the number of records of the buyer data before the occurrence of the “first pattern” is three, and the character strings set in the basket information field are “product 131”, “product 251”, and “product 382”. In contrast to this, as illustrated in FIG. 19, the number of records of the buyer data after the occurrence of the “first pattern” is four, and the character strings set in the basket information field include also “product 141” in addition to “product 131”,“product 251”, and “product 382” stored before the occurrence of the “first pattern”.

The following describes the updating of information in the case of the occurrence of the “second pattern” after the occurrence of the “first pattern” with reference to FIG. 20.

FIG. 20 is a table illustrating exemplary content of the product inventory data 271 after the occurrence of the “second pattern”. In the product inventory data 271 before the occurrence of the “second pattern”, the “position” of the record in which the product identification information is the “product 141” is the “buyer 120”, as illustrated in FIG. 17. In contrast, in the product inventory data 271 after the occurrence of the “second pattern”, the “position” of the record in which the product identification information is the “product 141” is the “shelf 140”, as illustrated in FIG. 20.

The content of the store-specific customer data 272 after the occurrence of the “second pattern” is the same as that illustrated in FIG. 14. The content of the buyer data after the occurrence of the “second pattern” is the same as that illustrated in FIG. 15.

The processing related to the updating of the various types of information contained in the first DB 27 as described with reference to FIGS. 17, 18, and 20 is performed by the DB processor 35 illustrated in FIG. 5. In the “first pattern” and the “second pattern” described with reference to FIG. 16, the products PAC placed on the shelf board with a sensing function SHB of the shelf SH, that is, the products PAC detected in the sensing area AA, have increased or decreased. Therefore, the sensing described above and the processing by the trigger detector 31, the timing controller 32, the image analyzer 33, and the determiner 34 have occurred. Therefore, the updating of the first DB 27 by the DB processor 35 reflects the result of the determination by the determiner 34.

The identification of who has moved which product may be performed along with the above-described processing as the trigger generator 12 in which the imager 121 captures images when the customer HC who has entered the product movement detection region CA illustrated in FIG. 2 takes the product 141 off the shelf SH, for example. Specifically, the customer HC may be identified based on the image of the customer HC included in the imaging region of the imager 121 and the captured image of the customer HC captured by the entry detector 43 when the customer HC enters the store ST. The operation of the first gate 40 and the second gate 50 may be controlled so as to limit the number of customers HC allowed to enter the store ST at the same time. With this operation, the number of customers HC allowed to move the product PAC in the store ST can be limited to one. Addition of the product 141 to the basket BAS, such as illustrated in FIG. 19, may be reflected to the database by voluntary updating of the buyer data by the customer HC using the terminal device 90.

When the customer HC takes the product PAC out of the store ST, that is, when the customer HC buys the product PAC, a payment process should be performed. For the payment process, a payment system (not illustrated), such as a payment process or the like using electronic money of a predetermined standard, may be used, or other payment processing methods determined in advance in the store ST may be used. The payment process that can be used to take the product PAC out of the store ST is determined in advance. A mechanism has been established that allows the payment processor 36 of the processor 30 to check, via the communication network NW, whether the payment process has been completed. When information is obtained, via the communication network NW, indicating that the payment for the product PAC held by the customer HC has been completed through the payment process, the payment processor 36 performs an updating process to change the payment flag of the record for that customer HC in the store-specific customer data 272 from 0 to 1. The customer HC whose total price is not 0 and whose payment flag is 1 in the store-specific customer data 272 and the customer HC whose total price is 0 in the store-specific customer data 272 are allowed to open the opening/closing mechanism 54 by allowing the second reader 52 of the second gate 50 illustrated in FIGS. 1 and 2 to read the identification information holder 99 of the terminal device 90, and whereby the customers can exit the store ST. In other words, the customer HC whose total price is not 0 and whose payment flag is 0 in the store-specific customer data 272 is not allowed to open the opening/closing mechanism 54 and cannot exit the store ST. The entry/exit processor 37 of the processor 30 illustrated in FIG. 5 controls the opening operation of the opening/closing mechanism 54. The entry/exit processor 37 also controls the operation of the opening/closing mechanism 44 associated with the operation of the first gate 40. The first gate 40 and the second gate 50 are coupled to the detection device 10 via the communication network NW and operate the opening/closing mechanism 44 and 54 under the control of the entry/exit processor 37.

In the embodiment, the customer HC uses the payment system or a payment method indicated by the payment information set in the record of the customer HC in the customer data 662. For example, the customer HC whose customer-specific number is “9123456780” illustrated in FIG. 11 makes payment using a payment system called “OO Pay”.

A communication device NWS in FIG. 2 is configured to make wireless communication in the store ST connectable to the communication network NW. When communication between the terminal device 90 and the detection device 10 is required, the communication is performed via the communication device NWS. Thus, the customer HC can use the payment system via the wireless communication even in the store ST. Naturally, the payment may be made using public wireless communication (for example, communication using a mobile communication system such as long-term evolution (LTE)) provided by the terminal device 90.

The information unique to the customer HC in the buyer data described with reference to FIGS. 15 and 19 corresponds to the in-store information in the store-specific customer data 272, but may be based on the customer-specific number.

FIG. 21 is a table illustrating exemplary content of the buyer data when the information unique to the customer HC in the buyer data is the customer-specific number. In the buyer data illustrated in FIG. 21, the customer-specific numbers in the buyer data described with reference to FIGS. 15 and 19 are replaced with the data corresponding to the in-store information in the store-specific customer data 272. Except for the points noted above, the buyer data illustrated in FIG. 21 is the same as the buyer data described with reference to FIGS. 15 and 19.

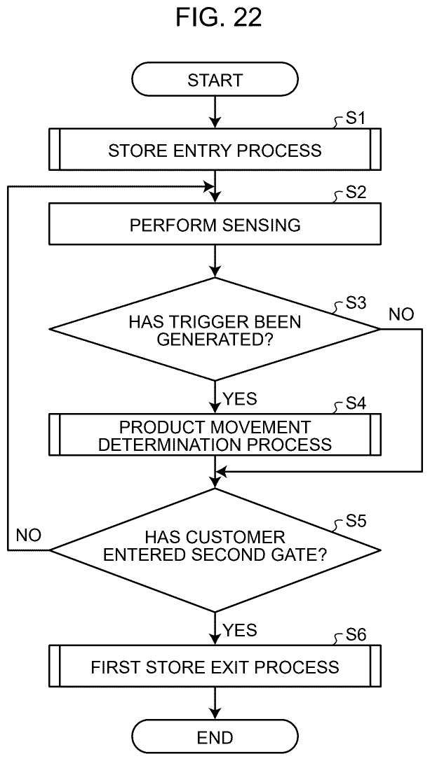

The following describes flows of processing involved in the management of the products in the store ST with reference to flowcharts illustrated in FIGS. 22 to 29.

FIG. 22 is a flowchart of processing when the payment process is automatically performed at the time of exit from the store ST. First, a store entry process is performed (Step S1).

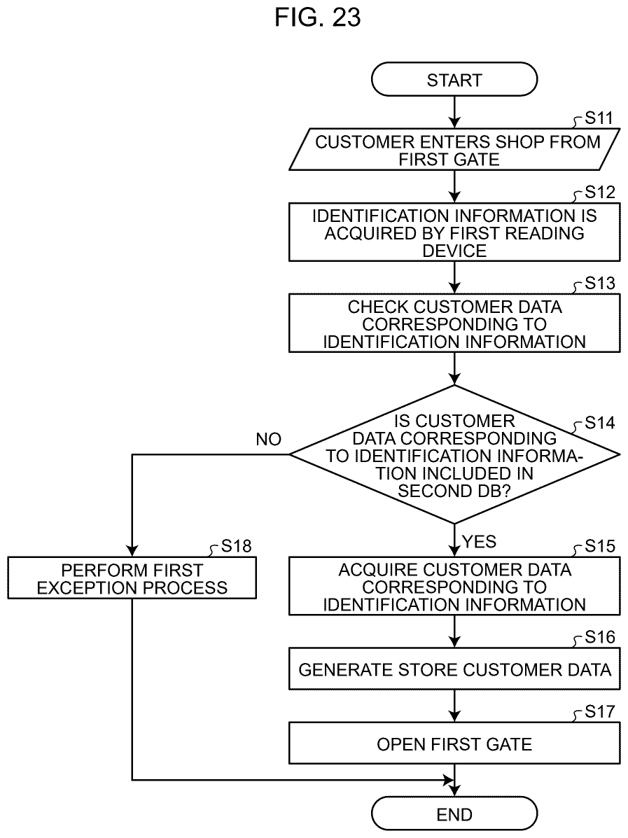

FIG. 23 is a flowchart of the store entry process. With entry of the customer HC into the store ST from the first gate 40, that is, with an occurrence of an act of entry of the customer HC into the first gate 40 (Step S11), the identification information is acquired by the first reader 42 (Step S12). The process at Step S12 is performed when the customer HC brings the terminal device 90 into proximity to the first reader 42. With the communication via the communication network NW, the entry/exit processor 37 refers to the product data 661 and checks whether a record containing a customer-specific number corresponding to the identification information acquired by the process at Step S12 is included in the customer data 662 of the second DB 66 (Step S13).

If it is determined that the record containing the customer-specific number corresponding to the identification information acquired by the process at Step S12 is included in the customer data 662 of the second DB 66 (Yes at Step S14), the entry/exit processor 37 acquires the record as the customer data of the customer HC who is about to enter the store ST (Step S15). The entry/exit processor 37 sets a new record in the store-specific customer data 272, and sets the customer-specific number of the new record to the number corresponding to the identification information acquired in the process at Step S12. The entry/exit processor 37 generates the new record as store customer data of the customer HC who is about to enter the store ST (Step S16). When the process at Step S16 is performed, the in-store information is automatically set based on predetermined rules. The initial values of the total price and the payment flag are “0”. The entry/exit processor 37 also outputs information that serves as a command to operate the opening/closing mechanism 44 of the first gate 40 so as to allow the customer HC about to enter the store ST to enter the store ST. This information is transmitted to the first gate 40 via the communication network NW. In response to the input of this information, the opening/closing mechanism 44 of the first gate 40 operates to open the first gate 40 (Step S17). The process at Step S16 and the process at Step S17 may be performed in no particular order, and may be performed in parallel, for example.

If it is determined that the record containing the customer-specific number corresponding to the identification information acquired by the process at Step S12 is not included in the customer data 662 of the second DB 66 (No at Step S14), a first exception process is performed (Step S18). The first exception process is a process performed when the record containing the customer-specific number is not included in the customer data 662 of the second DB 66, that is, when the customer is considered to be a new customer HC who has no experience of using the store ST. In the first exception process, various processes are performed to make the same processes as those from Step S15 to Step S17 applicable to the new customer HC, through registration of a new record into the customer data 662 corresponding to the new customer HC.

After the entry process described with reference to FIG. 23, the sensing is performed (Step S2), as illustrated in FIG. 22. That is, the sensor 11 operates to identify the types and the numbers of the products PAC placed on the shelf board with a sensing function SHB of the shelf SH at the time when the new customer HC has entered the store ST. The sensing results obtained in the process at Step S2 serve as the sensing results “before change” described with reference to FIGS. 6 and 8.

After the process at Step S2, if a trigger is generated (Yes at Step S3), a product movement determination process is performed (Step S4). The generation of the trigger in the process at Step S3 refers to an output by the trigger generator 12 described above. For example, the output of the image data captured by the imager 121 and the output associated with the detection of the change in weight by the weight sensor 125 correspond to the output by the trigger generator 12.

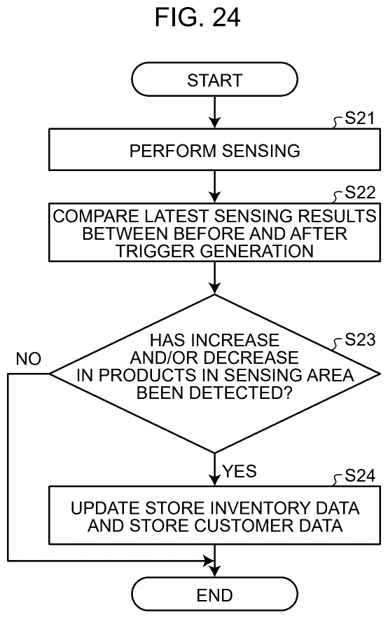

FIG. 24 is a flowchart of the product movement checking process. After the generation of the trigger in the process at Step S3, the sensing is performed (Step S21). The sensing results obtained in the process at Step S21 serve as the sensing results “after change” described with reference to FIGS. 6 and 8. The image analyzer 33 analyzes the sensing results obtained in the process at Step S2 and the sensing results obtained in the process at Step S21, and identifies the types of the products PAC and the number of each of the types of the products PAC included in each of the sensing results. The determiner 34 determines whether an increase or/and decrease in the products PAC in the sensing area AA has been detected, based on the results of the analysis by the image analyzer 33 (Step S22). Specifically, if the sensing results obtained at Step S2 match the sensing results obtained at Step S21 in the types of the products PAC and the number of each of the types of the products PAC, it is determined that an increase or/and decrease in the products PAC in the sensing area AA has not been detected. In other words, if the sensing results obtained at Step S2 do not match the sensing results obtained at Step S21 in the types of the products PAC and the number of each of the types of the products PAC, it is determined that an increase or/and decrease in the products PAC in the sensing area AA has been detected.

If, in the process at Step S23, an increase or/and decrease in the products PAC in the sensing area AA (Yes at Step S23) has been detected, the product inventory data 271 and the store-specific customer data 272 are updated (Step S24). To give a specific example, as illustrated in FIGS. 17 and 18 explained above, the product inventory data 271 and the store-specific customer data 272 are updated as a result of the customer HC taking the product PAC off the shelf SH and holding it. The specific content of the update corresponds to the specific content of the increase or/and decrease in the products PAC that has occurred in the sensing area AA. If, in the process at Step S23, an increase or/and decrease in the products PAC in the sensing area AA has not been detected (No at Step S23), the process at Step S24 is not performed.

As long as no trigger is generated in the process at Step S3 illustrated in FIG. 22 (No at Step S3), the product movement determination process (Step S4) is not performed. As long as no trigger is generated (No at Step S3), the processor 30 continues to stand by while being ready to respond to a process to be performed in a case where the trigger is generated (Yes at Step S3).

If the customer HC enters the second gate 50 (Yes at Step S5) after the product movement determination process described with reference to FIG. 24 or while no trigger is generated (No at Step S3), a first store exit process is performed (Step S6). Unless the customer HC enters the second gate 50 (No at Step S5), the process at Step S2 is performed again after the process at Step S4. That is, the sensing results obtained in the process at Step S2 performed after the process at Step S4 serve as the latest sensing results “before change”.

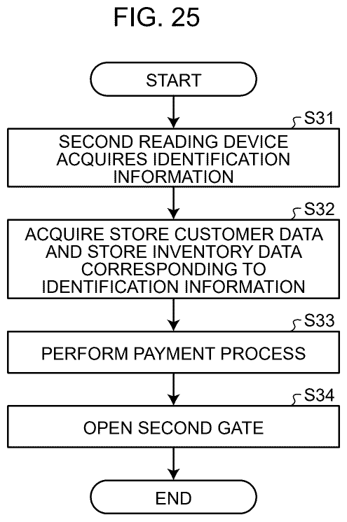

FIG. 25 is a flowchart of the first store exit process. First, the second reader 52 acquires the identification information (Step S31). The process at Step S31 is performed when the customer HC brings the terminal device 90 into proximity to the second reader 52. The entry/exit processor 37 acquires a record of the store-specific customer data 272 corresponding to the identification information acquired in the process at Step S31 as the store customer data and acquires a record of the product inventory data 271 corresponding to the identification information as store inventory data (Step S32). The payment processor 36 performs the payment process based on the data acquired by the entry/exit processor 37 in the process at Step S32 (Step S33). The payment process is determined in advance as described above. The mechanism has been established that allows the payment processor 36 of the processor 30 to check, via the communication network NW, that the payment process has been completed. When the information is obtained, via the communication network NW, indicating that the payment for the product PAC held by the customer HC has been completed through the payment process, the process at Step S33 is completed and the payment flag of the record in the store-specific customer data 272 corresponding to the customer HC is updated to 1. After the process at Step S33, the entry/exit processor 37 outputs information that serves as a command to operate the opening/closing mechanism 54 of the second gate 50 so as to allow the customer HC about to exit the store ST to exit the store ST. This information is transmitted to the second gate 50 via the communication network NW. In response to the input of this information, the opening/closing mechanism 54 of the second gate 50 operates to open the second gate 50 (Step S34).

Referring to FIGS. 22 through 25 above, the details of processing when the payment process is automatically performed upon exiting the store ST have been described. The following describes the processing when the customer HC uses the terminal device 90 to voluntarily manage the products PAC taken off the shelf SH by the customer HC.

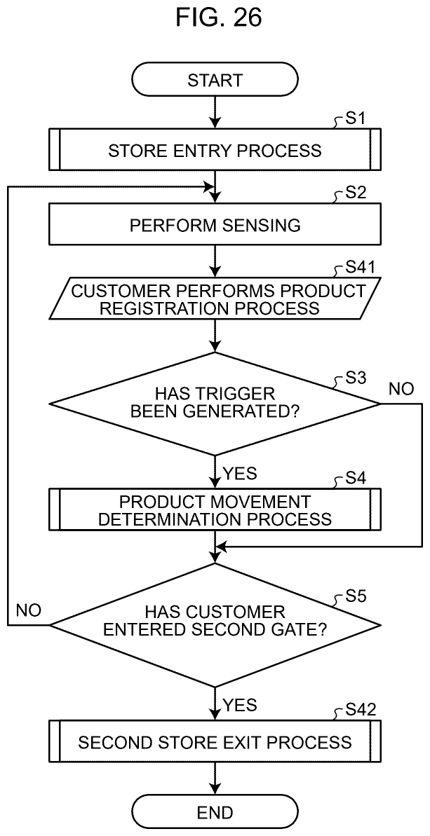

FIG. 26 is a flowchart of processing when the customer HC voluntarily manages the products PAC taken off the shelf SH using the terminal device 90. Even in this case, the processing involved in the processes at Step S1 and at Step S2 is the same as that described with reference to FIG. 22.

When the customer HC voluntarily manages the products PAC taken off the shelf SH using the terminal device 90, for example, the customer HC performs a product registration process (Step S41) before the process at Step S3 described with reference to FIG. 22. The process at

Step S41 is a process to register, into the terminal device 90, the type and the number of the product PAC taken off the shelf SH by the customer HC. By the process at Step S41, the buyer data described with reference to FIG. 15 and other drawings is generated in the terminal device 90, and information corresponding to the product PAC taken out is registered in each record of the buyer data. In FIG. 26, the processes at Steps S3, S4, and S5 described with reference to FIG. 22 occur after Step S41, but the processes at Steps S3 and S4 and the process at Step S41 may be performed in no particular order.

As indicated by the relation between the process at Step S2 illustrated in FIG. 26 and the process at Step S21 (refer to FIG. 24) included in the process at Step S4, the sensor (sensor 11) operates before and after the trigger is generated. If the component that generates the trigger is the imager 121, the sensor (sensor 11) operates before and after the movement of the product between the customer HC and the shelf SH is imaged by the imager 121 in the product movement detection region CA. Assume a case where the number of products has decreased after the sensing compared with before the sensing, as described with reference to FIGS. 6 and 8. In this case, as described with reference to FIGS. 16 to 19, products corresponding to the reduction of the products are regarded to be held by the customer HC. Therefore, in the embodiment, the information processor 20 compares the sensing results by the sensor 11 before the movement of the products between the customer HC and the shelf SH is imaged by the imager 121 with the sensing results after the movement of the products is imaged. Then, the information processor 20 determines whether the types of the products PAC and the number of each of the types of the products PAC have changed between before and after the imaging. If the number of the products PAC in the sensing area AA has decreased, the information processor 20 regards that the products PAC corresponding to the reduction of the products PAC placed in the sensing area AA are held by the customer HC.

If the component that generates the trigger is the weight sensor 125, the sensor (sensor 11) operates before and after the weight sensor 125 detects the change in weight. In the embodiment, the information processor 20 compares the sensing results by the sensor 11 before the weight sensor 125 detects the change in weight with the sensing results after the weight sensor 125 detects the change in weight. Then, the information processor 20 determines whether the types of the products PAC and the number of each of the types of the products PAC in the sensing area AA have changed between before and after the detection.

In a case where the customer HC uses the terminal device 90 to voluntarily manage the products PAC taken off the shelf SH by the customer HC, when the customer HC enters the second gate 50 in the process at Step S5 (Yes at Step S5), a second store exit process is performed (Step S42).

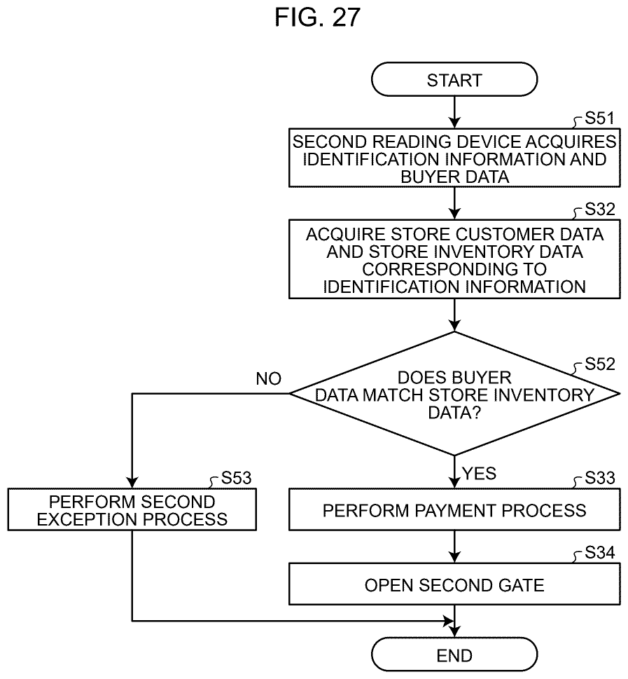

FIG. 27 is a flowchart of the second store exit process. First, the second reader 52 acquires the identification information and the buyer data (Step S51). The process at Step S51 is performed when the customer HC brings the terminal device 90 into proximity to the second reader 52. The process at Step S51 is different from the process at Step S31 described with reference to FIG. 25 in that the entry/exit processor 37 acquires not only the identification information but also the buyer data from the terminal device 90. After the process at Step S51, the process at Step S32 described with reference to FIG. 25 is performed.

After the process at Step S32, the payment processor 36 performs a matching process to check whether the buyer data acquired in the process at Step S51 matches the product inventory data 271 in the first DB 27 (Step S52). It is determined that the buyer data acquired in the process at Step S52 matches the product inventory data 271 in the first DB 27 (Yes at Step S52), for example, when the following conditions are satisfied: the “position” for three records in which the product identification information is “product 131”, “product 251”, and “product 382” is “buyer 120”, such as in a case of the product inventory data 271 described with reference to FIG. 13; the “basket information” includes the three records of “product 131”, “product 251”, and “product 382”, such as in a case of the buyer data described with reference to FIG. 15; and the user of the buyer data is the customer HC to whom “buyer 120” is assigned,. In other words, if at least one of mismatch in type and number of the products or mismatch in identification of the customer HC is detected, it is determined that the buyer data acquired in the process at Step S52 does not match the product inventory data 271 in the first DB 27 (No at Step S52).

The process at Step S52 is a process to determine, at the time of payment, whether the information indicated by the product inventory data 271 in the first DB 27 matches the information indicated by the buyer data. Specifically, the information indicated by the product inventory data 271 includes the type and the number of the product PAC regarded to be held by the customer HC. The information indicated by the buyer data includes the type and the number of the product intended to be bought by the customer indicated by data managed in the terminal device 90 of the customer HC.

If it is determined that the buyer data acquired in the process at Step S52 matches the product inventory data 271 in the first DB 27 (Yes at Step S52), the processes at Steps S33 and S34 described with reference to FIG. 25 are sequentially performed. In contrast to this, if it is determined that the buyer data acquired in the process at Step S52 does not match the product inventory data 271 in the first DB 27 (No at Step S52), a second exception process is performed (Step S53). The second exception process is a process to identify the cause of the mismatch and correct the mismatch between the buyer data acquired in the process at Step S52 and the product inventory data 271 in the first DB 27, and is manually performed, for example through communication between staff of the store ST and the customer HC.

Except for the matters noted above, the processing when the customer HC uses the terminal device 90 to voluntarily manage the products PAC taken off the shelf SH by the customer HC is the same as the processing when the payment process is automatically performed at the time of exit from the store ST.

The above has further described the processing when the customer HC uses the terminal device 90 to voluntarily manage the products PAC taken off the shelf SH by the customer HC, with reference to FIGS. 26 and 27. The following describes processing when the customer HC is assumed to use a self-checkout system to complete the payment before entering the second gate 50.

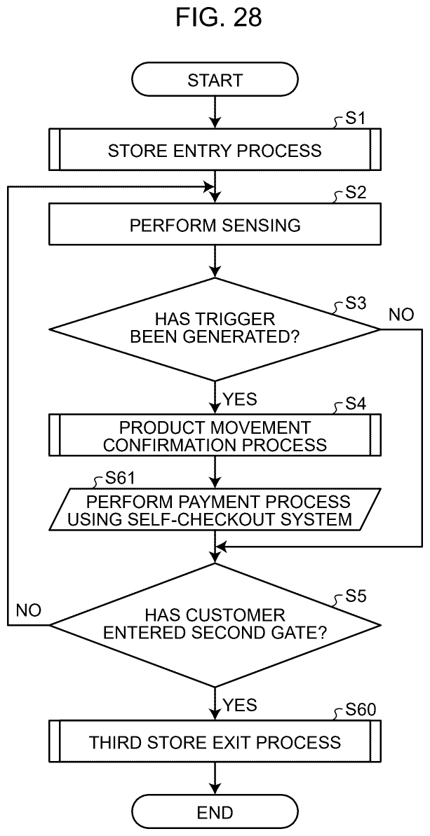

FIG. 28 is a flowchart of processing when the customer HC is assumed to use the self-checkout system to complete the payment before entering the second gate 50. When the customer HC is assumed to use the self-checkout system to complete the payment before entering the second gate 50, the payment process using the self-checkout system is performed (Step S61) between the process at Step S4 and the process at Step S5 in the processing when the payment process is automatically performed at the time of exit from the store ST described with reference to FIG. 22.

The process at Step S61 is the process in which the customer HC uses the self-checkout system to voluntarily complete the payment before entering the second gate 50. In the embodiment, as illustrated in FIG. 2, a self-checkout system SCH for the customer HC to perform the process at Step S61 is provided in the store ST.

In the process described with reference to FIG. 25, the payment process is automatically performed at the time of exit from the store ST. In contrast to this, assuming a case where the customer HC uses the self-checkout system to complete the payment before entering the second gate 50. In this case, the process at Step S6 in the processing described with reference to FIG. 25 is replaced with a third store exit process (Step S60).

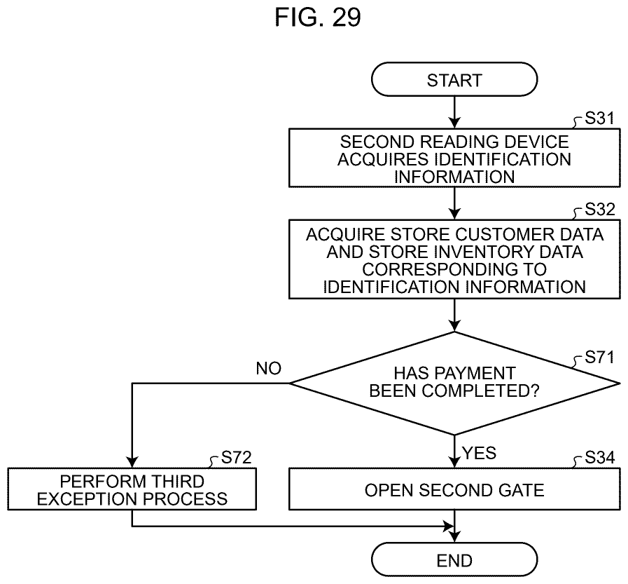

FIG. 29 is a flowchart of the third store exit process. In the third store exit process, first, the processes at Steps S31 and S32 described with reference to FIG. 25 are performed.

After the process at Step S32, the payment processor 36 checks whether the customer HC who has entered the second gate 50 in the process at Step S5 has completed payment (Step S71). Specifically, a check is made as to whether the payment flag in the store-specific customer data 272 acquired at Step S32 is 1. If the payment flag in the store-specific customer data 272 is 1, it is determined that the payment has been completed (Yes at Step S71), and the process at Step S34 described with reference to FIG. 25 is performed. In contrast to this, if the payment flag in the store-specific customer data 272 is 0, it is determined that the payment has not been completed (No at Step S71), and a third exception process is performed (Step S72). The third exception process is performed to allow the customer HC to complete the payment and is manually performed, for example through communication between the staff of the store ST and the customer HC.

Except for the matters noted above, the processing when the customer HC uses the self-checkout system to complete the payment before entering the second gate 50 is the same as the processing when the payment process is automatically performed at the time of exit from the store ST.

The shape of the product PAC illustrated in FIG. 4 and other drawings is a shape having a surface that can be stably placed on the sensing area AA, but, depending on the form of the product, no surface may be present that can be stably placed on the sensing area AA. For such a product, preliminary measures may be taken to provide a surface that can be stably placed on the sensing area AA.

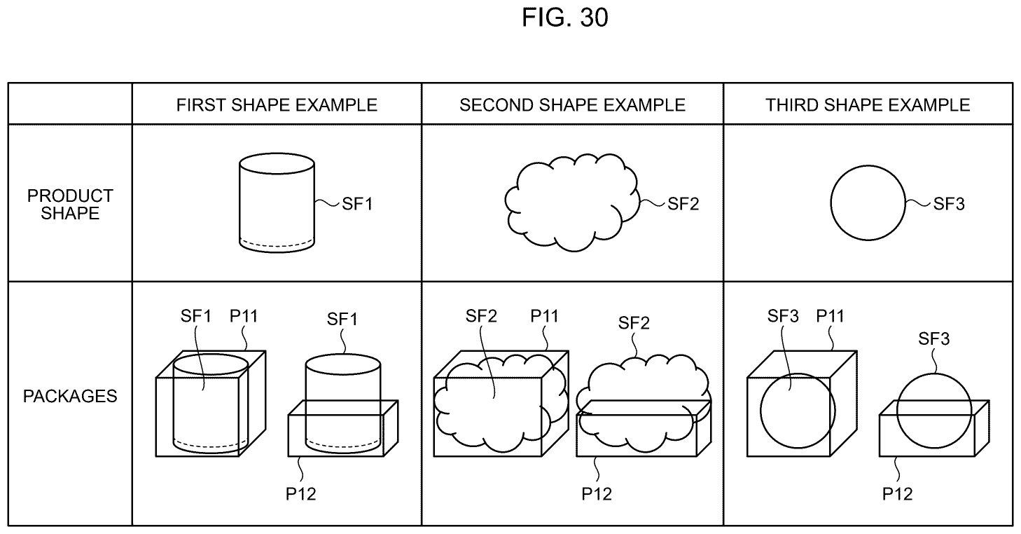

FIG. 30 is a schematic diagram illustrating exemplary preliminary measures for providing surfaces that can be stably placed on a sensing area AA to products having shapes that have no surfaces that can be stably placed on the sensing area. FIG. 30 illustrates a product SF1 illustrated as a “first shape example”, a product SF2 illustrated as a “second shape example”, and a product SF3 illustrated as a “third shape example”, as examples of products having shapes that have no surfaces that can be stably placed on the sensing area.

The product SF1 is a product, such as a can of canned goods, that has a cylindrical outer shape, has a shape in which a circumferential edge on the bottom surface of the cylinder protrudes beyond the inside of the circumference, and contacts the placement surface only at the circumferential edge. The product SF2 is a product that does not have a flat surface with which the product can be stably placed on the sensing area AA, or even if the product SF2 has a flat surface, the flat surface is much smaller than the overall size of the product, thus not having a shape with which the product can be stably placed thereon. The examples of the product SF2 also include products that are the same type but are slightly different in shape in a precise sense. The product SF3 is a spherical product.

By performing packaging using a package P11 that can accommodate the product or an open package P12 that can accommodate at least a lower part of the product, any one of the products SF1, SF2, and SF3 can be provided with a surface that can be stably placed on the sensing area AA. The bottom of the package P11 or the package P12 serves as a surface that can be stably placed on the sensing area AA. That is, the product packaged in the package P11 or the package P12 can be handled in the same way as the product PAC described above.

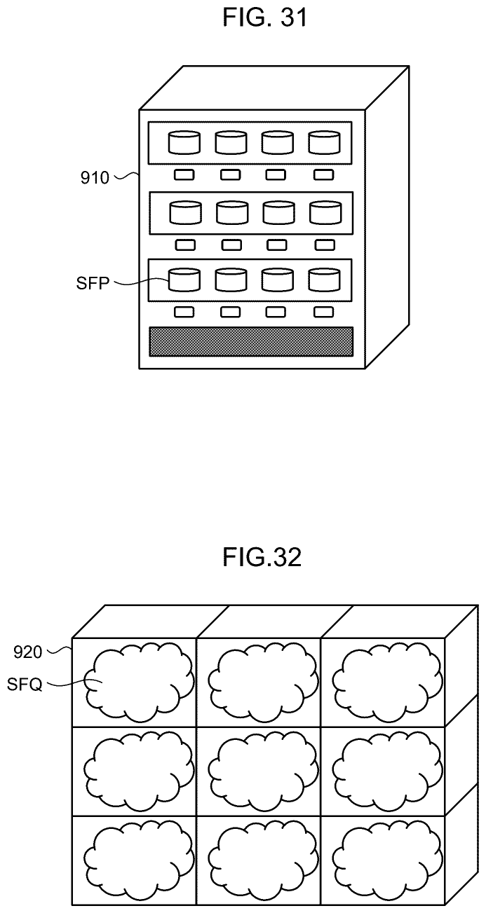

In the embodiment described above, the products are assumed to be placed on the shelf board with a sensing function SHB of the shelf SH described with reference to FIGS. 3 and 4, but the sensor 11 is not limited to being provided on the shelf board with a sensing function SHB. The following describes other forms to provide the sensor 11 with reference to FIGS. 31 and 32.

FIG. 31 is a schematic diagram illustrating a vending machine 910 accommodating products SFP. In the vending machine 910 illustrated in FIG. 31, each of the products SFP is automatically discharged to an outlet according to an amount of money put in by a function as a vending machine. In this case, the movement of the product SFP can be automatically detected by providing the sensor 11 at the bottom of a space where the products SFP are stored in the vending machine 910.

FIG. 32 is a schematic diagram illustrating a locker 920 accommodating products SFQ. The locker 920 illustrated in FIG. 32 is provided with an openable locker frame that accommodates each of the products SFQ according to an amount of money put in, as a function as a locker usable for a charge. In this case, the movement of the product SFQ can be automatically detected by providing the sensor 11 at the bottom of each of the locker frames.

As described above, according to the embodiment, the detection system 1 includes the server (server 60) that holds the pattern data (optical identification pattern) for identifying the types of products handled in stores, and the detection device (detection device 10) that is provided so as to be capable of communicating with the server and identifies the products. The detection device includes the sensor (sensor 11) provided along the placement surface of the shelf provided so as to allow a plurality of products (products PAC) to be placed thereon, and the information processor (information processor 20) that identifies the types of the products and the number of each of the types of the products by checking the output of the sensor against the pattern data. The sensor includes the planar optical sensor (planar optical sensor 81) located so as to face the products with the placement surface interposed therebetween. The planar optical sensor has a resolution capable of identifying the shape of one surface, which faces the placement surface, of each of the products placed on the placement surface and characters, identifiers, and patterns marked on the one surface. The pattern data includes the information indicating the shape of the one surface, and the characters, the identifiers, and the patterns marked on the one surface (refer to FIG. 7).

This configuration allows sensing of the products (products PAC) on the placement surface under the simple arrangement condition that the planar optical sensor (planar optical sensor 81) of the sensor is provided under the placement surface of the shelf. Therefore, the products (products PAC) on the placement surface can be sensed without being subject to restrictions, such as the image region and the view angle of the imaging device. Thus, according to the embodiment, the detection system (detection system 1) that can more reliably sense the products and is easier to install can be provided.

In addition, the planar optical sensor (planar optical sensor 81) is less constrained by optical conditions, such as a focal length with respect to the products (products PAC), than the imaging device. In particular, when a plurality of the shelves are provided on one shelf SH as illustrated in FIG. 3, the small number of restrictions greatly contributes to the ease of installation of the detection system. For example, as far as the top shelf board of the shelf SH shown in FIG. 3 (shelf board SHB1 with sensing function) is concerned, no particular restriction can be found for setting up an imaging device 900 to image the shelf board. However, when an imaging device is provided on the lower side of the shelf board with a sensing function SHB1 illustrated in FIG. 3, the products PAC1 placed on the shelf board with a sensing function SHB2 can be imaged. Thus, the products PAC1 can be managed. In this case, the imaging device needs to be provided that is capable of imaging all the products PAC1 on the shelf board with a sensing function SHB2 within the imaging region, using a distance D3 as the focal length.

The distance D3 is a distance obtained by subtracting a height D2 of the product PAC1 from a distance D1 between the shelf board with a sensing function SHB1 and the shelf board with a sensing function SHB2. When an imaging device is provided on the lower side of the shelf board with a sensing function SHB2 illustrated in FIG. 3, the products PAC2 placed on the shelf board with a sensing function SHB3 can be imaged. Thus, the products PAC2 can be managed. In this case, the imaging device needs to be provided that is capable of imaging all the products PAC2 on the shelf board with a sensing function SHB3 within the imaging region, using a distance D6 as the focal length. The distance D6 is a distance obtained by subtracting a height D5 of the product PAC2 from a distance D4 between the shelf board with a sensing function SHB2 and the shelf board with a sensing function SHB3. When an imaging device is provided on the lower side of the shelf board with a sensing function SHB3 illustrated in FIG. 3, the products PAC3 placed on the shelf board with a sensing function SHB4 can be imaged. Thus, the products PAC3 can be managed. In this case, the imaging device needs to be provided that is capable of imaging all the products PAC3 on the shelf board with a sensing function SHB4 within the imaging region, using a distance D9 as the focal length. The distance D9 is a distance obtained by subtracting a height D8 of the product PAC3 from a distance D7 between the shelf board with a sensing function SHB3 and the shelf board with a sensing function SHB4. Moreover, the heights of the products PAC placed on each of the shelf boards with a sensing function SHB2, SHB3, and SHB4 are not necessarily uniform, and some of the products PAC may block the view angles to some of the other products PAC. In contrast to this, a planar optical sensor such as the planar optical sensor 81 causes virtually no such technical difficulties related to the focal length and no such problems of view angles. Therefore, according to the embodiment, the detection system (detection system 1) that can more reliably sense the products and is easier to install can be provided.

The sensor (sensor 11) includes the light guide plate (light guide plate 2) and the light source (light source 7). The light guide plate is located so as to face the products with the placement surface of the shelf interposed therebetween, the products being placed on the placement surface of the shelf that is provided so as to allow the products (products PAC) to be placed thereon. The light source (light source 7) emits light from a lateral side of the light guide. The planar optical sensor (planar optical sensor 81) is located so as to face the products with the light guide interposed therebetween. As a result, the light sources used when the planar optical sensor senses the products can be concentrated on the opposite side of the products with placement surface interposed therebetween, that is, on the side where the planar optical sensor is provided. Therefore, the detection system (detection system 1) that can more reliably sense the products and is easier to install can be provided.

The detection device (detection device 10) includes the imager (imager 121) that captures the moving image. The imaging region of the image captured by the imager covers a movement path (product movement detection region CA) of the product between the customer (customer HC) of the store (store ST) and the shelf (shelf SH). The sensor (sensor 11) operates before and after the imager images the movement of the product between the customer and the shelf. The information processor (information processor 20) compares the sensing results by the sensor between before and after the movement of the product between the customer and the shelf is imaged by the imager and determines whether the types of the products placed on the placement surface of the shelf provided so as to allow the products (products PAC) to be placed thereon and the number of each of the types of the products have changed between before and after the imaging. If the number of the products placed on the placement surface has decreased after the imager imaged the movement of the product between the customer of the store and the shelf as compared with before the imager imaged the movement of the product between the customer and the shelf, the information processor regards that the products corresponding to the reduction of the products placed on the placement surface are held by the customer (refer to FIGS. 6, 8, 16 to 19, 24, and 26). This configuration can control the operation of the sensor using the imager, and can operate the sensor only before and after the time when the movement of the product is likely to occur, without a full-time operation of the sensor. The movement of the product from the shelf to the customer can be tracked.

The detection device (detection device 10) includes the weight sensor (weight sensor 125) that detects a change in weight of the shelf (shelf SH). The sensor (sensor 11) operates before and after the weight sensor detects the change in weight. The information processor (information processor 20) compares the sensing results by the sensor between before and after the detection of the change in weight by the weight sensor, and determines whether the types of the products placed on the placement surface of the shelf provided so as to allow the products (products PAC) to be placed thereon and the number of each of the types of the products have changed between before and after the detection, thereby being capable of controlling the operation of the sensor using the weight sensor, and capable of operating the sensor only before and after the time when the movement of the product is likely to occur, without a full-time operation of the sensor.

The server (server 60) further stores therein the customer information (customer data 662) corresponding to the identification information of the terminal device (terminal device 90) of the customer (customer HC) and price information (product data 661) indicating prices of various products. The customer information includes the information indicating the service used by the customer at the time of payment. At the time of payment using the service, a determination is made as to whether the type and the number of products regarded to be held by the customer match the type and the number of products intended to be bought by the customer indicated by the data (refer to FIGS. 15 and 19) managed by the terminal device (refer to the process at Step S52 illustrated in FIG. 27). As a result, the accuracy in tracking the movement of the products can be increased.

The imager 121 may be provided for each of the shelf boards with a sensing function SHB. In that case, the weight sensor 125 is provided, for example, between the shelf board BOA and the support member SUP, but is not limited to this location, and the location of the weight sensor 125 may be changed as appropriate. The weight sensor 125 only needs to be capable of detecting the movement of the product PAC in the sensing area AA as a change in weight.

The images of the products PAC included in the images in the product movement detection region CA captured by the imager 121 may be further used to identify the type and number of the products PAC by pattern matching, and may be compared with the results of identification of the type and number of the products PAC by the sensor 11 to further increase the accuracy. The weight sensing of the products PAC by the weight sensor 125 may be further used to identify the moved product PAC. In this case, an additional column for “product weight” is further added to the product data 661, and a numerical value indicating the weight of various products is set in the field of this column.

Other operational advantages accruing from the aspects described in the present embodiment that are obvious from the description herein, or that are conceivable as appropriate by those skilled in the art will naturally be understood as accruing from the present disclosure.

What is claimed is:

1. A detection system comprising: a server configured to hold pattern data to identify a type of a product handled in a store; and a detection device provided so as to be capable of communicating with the server and configured to identify the product, wherein
the detection device comprises:
a sensor provided along a placement surface of a shelf provided so as to allow a plurality of the products to be placed thereon; and
an information processor configured to identify types of the products and the number of each of the types of the products by comparing an output of the sensor to the pattern data,
the sensor comprises a planar optical sensor located so as to face the products with the placement surface interposed between the planar optical sensor and the products,
the planar optical sensor has a resolution capable of identifying a shape of one surface, which faces the placement surface, of each of the products placed on the placement surface, and characters, identifiers, and patterns marked on the one surface, and
the pattern data comprises information indicating the shape of the one surface, and the characters, the identifiers, and the patterns marked on the one surface.

2. The detection system according to claim 1, wherein
the sensor comprises:
a light guide plate located so as to face the products placed on the placement surface with the placement surface interposed between the light guide plate and the products; and
a light source configured to emit light from a lateral side of the light guide plate, wherein
the planar optical sensor is located so as to face the products with the light guide plate interposed between the planar optical sensor and the products.

3. The detection system according to claim 1, wherein
the detection device comprises an imager configured to capture a moving image,
an imaging region of an image captured by the imager covers a movement path of the products between a customer of the store and the shelf,
the sensor is configured to operate before and after the movement of the products between the customer of the store and the shelf is imaged by the imager, and
the information processor is configured to
compare results of sensing by the sensor between before and after the movement of the products between the customer of the store and the shelf is imaged by the imager,
determine whether the types of the products placed on the placement surface and the number of each of the types of the products have changed between before and after the imaging, and
regard that the products corresponding to the reduction of the products placed on the placement surface are held by the customer when the number of the products placed on the placement surface has decreased after the imager imaged the movement of the product between the customer of the store and the shelf as compared with before the imager imaged the movement of the products between the customer of the store and the shelf.

4. The detection system according to claim 1, wherein
the detection device comprises a weight sensor configured to detect a change in weight of the shelf,
the sensor is configured to operate before and after the weight sensor detects the change in weight, and
the information processor is configured to compare results of sensing by the sensor between before and after the detection of the change in weight by the weight sensor, and determine whether the types of the products placed on the placement surface and the number of each of the types of the products have changed between before and after the detection.

5. The detection system according to claim 3, wherein
the server is configured to further store customer information corresponding to identification information of a terminal device held by the customer and price information indicating prices of various products,
the customer information comprises information indicating a service used by the customer at a time of payment, and
at the time of the payment using the service, a determination is made as to whether types and numbers of products regarded to be held by the customer match types and numbers of products intended to be bought by the customer indicated by data managed by the terminal device.
